(19) United States
(12) Patent Application Publication
(10) Pub. No.: US 2015/0177630 A1
(43) Pub. Date: Jun. 25, 2015

(54) TONER MANUFACTURING METHOD

(71) Applicant: CANON KABUSHIKI KAISHA, Tokyo (JP)

(72) Inventors: Noriyoshi Umeda, Suntou-gun (JP); Kunihiko Nakamura, Gotemba-shi (JP); Yoshiaki Shiotari, Mishima-shi (JP); Shuhei Moribe, Mishima-shi (JP); Kosuke Fukudome, Tokyo (JP); Satoshi Mita, Fukuyama-shi (JP); Naoki Okamoto, Mishima-shi (JP); Tetsuya Ida, Mishima-shi (JP)

(21) Appl. No.: 14/572,625

(22) Filed: Dec. 16, 2014

(30) Foreign Application Priority Data
Dec. 20, 2013 (JP) 2013-264229

(51) Int. Cl. G03G 9/08

(52) U.S. Cl. CPC G03G 9/0802

(57) ABSTRACT

A toner manufacturing method includes a first mixing process of mixing toner base particles, each of which contains a colorant, a crystalline resin, an amorphous resin, and wax with inorganic fine particles to obtain a mixture and a second mixing process of further mixing the mixture, in which, in both the mixing processes, a stirring unit for imparting mechanical impact force is used and the processing is performed at a specific processing temperature (° C.) with a specific stirring power (W/kg).

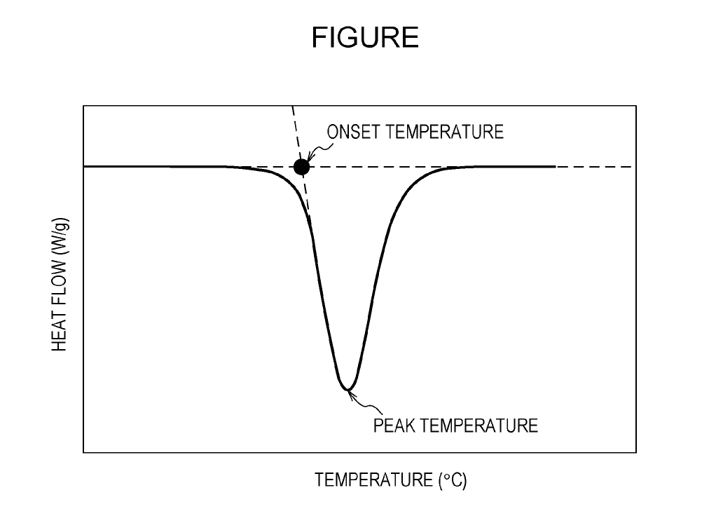

### BACKGROUND OF THE INVENTION

1. Field of the Invention

The present invention relates to a method for manufacturing a toner for use in recording methods using an electrophotographic method, an electrostatic recording method, and a toner jet recording method.

2. Description of the Related Art

In recent years, also in an electrophotographic apparatus, energy saving is regarded as a major technical subject, and a sharp reduction in the amount of heat required in a fixing device has been examined. Therefore, in toner, a need for fixability at lower energy, a so-called “low-temperature fixability”, has increased.

As a method for enabling fixing at a low temperature, a reduction in the glass transition point (Tg) of a binding resin in toner is mentioned. However, a reduction in Tg leads to loss of heat-resistant property of toner on a storage or a deterioration of the toner surface due to stress in development. Therefore, it has been considered to be difficult to simultaneously achieve low-temperature fixability, heat-resistant property of toner on a storage, and suppression of deterioration of toner when forming a large number of images of low printing quality under a severe environment.

As a material for the binding resin for achieving the low-temperature fixability and the heat-resistant storageability, a crystalline resin has particularly drawn attention in recent years. The crystalline resin has been known to form a structure in which polymer chains constituting the resin are regularly arranged and have no clear Tg and have a melting point (Tm). Therefore, the crystalline resin has a property (sharp melt property) that the resin is difficult to be softened in a temperature region of less than the melting point of the crystal and the crystal dissolves at or higher than the melting point to cause a sharp reduction in viscosity. Based on this fact, an examination of toner in which the crystalline resin is added to an amorphous binding resin has been actively performed.

However, when the crystalline resin is used as a toner material, a usual toner manufacturing process requires a process of imparting a heat history equal to or higher than the melting point or dissolving the resin in an organic solvent with other materials. Therefore, dissolution with an amorphous binding resin occurs, so that the crystallinity is likely to be impaired. Thus, it is not easy to allow the crystalline resin to be present in toner while holding the crystallinity of the crystalline resin and, in usual, the crystalline resin and the amorphous resin are easily dissolved. More specifically, Tg of the amorphous resin is kept low due to the fact that the crystalline resin is dissolved in the amorphous resin of toner, and therefore the heat-resistant storageability at a temperature higher than Tg may deteriorate.

Furthermore, since the toner in the dissolution state is in a state where the toner surface is soft. Therefore, an external additive on the toner surface deteriorates due to stress in development, which may cause a further reduction in the chargeability and the transferability of the toner.

In order to solve such problems, it has been attempted to reconstruct a crystal structure by heating a toner intermediate containing a crystalline resin with lowered crystallinity or toner at a temperature less than the melting point of the crystalline resin. By holding the polymer chains in the crystalline resin at a high temperature, the molecular mobility increases, so that a crystal structure which is a more stable structure is likely to form. However, when the polymer chains are held at a temperature higher than the melting point of the crystal, the crystalline resin dissolves, so that the crystal structure is broken.

For example, Japanese Patent Laid-Open No. 2005-308995 has proposed a toner manufacturing method including melting and kneading raw materials containing crystalline polyester and amorphous polyester, performing heat treatment at a temperature equal to or higher than the glass transition temperature of the melted and kneaded substance and 10° C. less than the softening point of the amorphous polyester, and then crushing the heat-treated substance. However, according to this method, since the particle diameter of the melted and kneaded substance is large, the heat is difficult to be transmitted to the inside of the melted and kneaded substance. Therefore, it cannot be said that the crystallization in the melted and kneaded substance is sufficiently performed. Since a dissolved portion and a crystal portion are present on the interface of the crystalline polyester resin and the amorphous polyester resin by the subsequent pulverization, the hardness of the surface of the toner base particles is likely to vary. When an external additive is added to the toner base particles, the buried degree of the external additive in the surface of each toner base particle varies, so that the transferability of toner has deteriorated in some cases.

Japanese Patent Laid-Open No. 2006-065015 has proposed a toner manufacturing method including storing an intermediate or a final product of a process of manufacturing toner containing crystalline polyester and amorphous polyester as a binding resin at a temperature in the range of 45 to 65° C. According to this method, the dissolved portion on the interface of the crystalline polyester and the amorphous polyester is crystallized. However, due to the storage in a stationary state, the crystallization takes a long time period. On the other hand, when the mixing time period is shortened considering the productivity, the heat transmitting manner to each toner base particle may vary. Therefore, the crystallinities have been nonuniform in the toner base particles to which heat is easily transmitted and the toner base particles to which heat is not easily transmitted in some cases.

Japanese Patent Laid-Open No. 2010-170031 has proposed a toner manufacturing method including a process of treating toner containing crystalline polyester and amorphous polyester at a ±10° C. temperature of the glass transition point (Tg) of toner base particles in external addition processing of attaching inorganic fine particles and fluorine resin to the toner as an external additive. According to this method, since heat is uniformly transmitted to each toner base particle, the crystalline polyester is crystallized, so that the heat-resistant storageability of the toner can be improved. However, the surface of the toner base particles is uneven, and therefore when the external additive is attempted to be firmly attached, the external additive is excessively buried in protrusions of the surface of the toner base particles or the external additive moves to the recesses of the surface of the toner base particles from the protrusions, so that there has been a tendency for the coverage of the protrusions to decrease. As a result, the present state of the external additive on the surface of each toner base particle becomes nonuniform, and therefore the transferability of the toner has been insufficient in some cases.

As described above, a toner manufacturing method has not been found which enables promotion of the crystallization of crystalline resin for elimination of the variation in the crystallinity of the entire toner and uniform burying and fixing of an external additive irrespective of a difference in the uneven state of the surface of toner base particles.

### SUMMARY OF THE INVENTION

The present invention provides a toner manufacturing method in which the above-described problems are solved. More specifically, the present invention provides a method for manufacturing toner which can achieve heat-resistant storageability, while having excellent low-temperature fixability, by promoting crystallization of crystalline resin in toner particles to uniformly increase the crystallinity of the entire toner. Furthermore, the present invention provides a manufacturing method capable of easily obtaining toner which is resistant to deterioration in low printing durability under a severe environment by uniformly fixing inorganic fine particles to the toner surface to thereby increase the transferability.

The purpose can be achieved by the present invention of the following configuration.

A toner manufacturing method includes a first mixing process of mixing toner base particles, each of which contains a colorant, a crystalline resin, an amorphous resin, and wax with inorganic fine particles to obtain a mixture and a second mixing process of mixing the mixture, in which the first mixing process and the second mixing process are processes of performing the mixing using a mixing device having a stirring unit for imparting mechanical impact force in a container and when the processing temperature in the first mixing process is indicated as T₁ (° C.), the stirring power of the mixing device imparted to the unit mass of a coated material in the first mixing process is indicated as W₁ (W/kg), the processing temperature in the second mixing process is indicated as T₂ (° C.), and the stirring power of the mixing device imparted to the unit mass of a coated material in the second mixing process is indicated as W₂ (W/kg), the following expressions (1), (2), (3), and (4) are satisfied.

TgA≦T₁≦Tp (1)

TgA≦T₂≦Tp (2)

3≦W₂ (3)

W₂≦½W₁ (4)

In the expressions, Tp (° C.) shows the onset temperature of the maximum endothermic peak derived from the crystalline resin measured when the temperature is raised from 20° C. to 180° C. at a temperature rise rate of 10/min in differential scanning calorimeter (DSC) measurement in which the toner base particles are measurement specimens.

TgA (° C.) shows the glass transition temperature in a second temperature rise measured when the temperature is raised from 20° C. to 180° C. at a temperature rise rate of 10° C./min, the temperature is reduced to 20° C. at a temperature decrease rate of 50° C./min, and then the temperature is raised from 20° C. to 180° C. at a temperature rise rate of 10° C./min in the DSC measurement in which the toner base particles are measurement specimens.

Further features of the present invention will become apparent from the following description of exemplary embodiments with reference to the attached drawings.

### BRIEF DESCRIPTION OF THE DRAWINGS

FIGURE is a view showing the onset temperature of the endothermic peak observed in a temperature rise process in differential scanning calorimeter (DSC) measurement.

### DESCRIPTION OF THE EMBODIMENTS

The present inventors have examined the effects obtained by the processing temperature and the stirring power in mixing of materials in toner manufacturing. As a result, the present inventors have found that, by dividing a material mixing process into two or more stages and changing the processing temperature and the stirring power of each mixing process, uniform fixation of inorganic fine particles to toner base particles and uniform increase in the crystallinity of the entire toner, which have not been achieved only by one mixing process, can be achieved.

More specifically, the toner manufacturing method of the present invention has a first mixing process of mixing inorganic fine particles with toner base particles, each of which contains a crystalline resin and an amorphous resin to obtain a mixture and a second mixing process. The first mixing process and the second mixing process are processes of performing the mixing using a mixing device having a stirring unit for imparting mechanical impact force in a container. By controlling the processing temperature and the stirring power of the first mixing process and the second mixing process, uniform sticking of the inorganic fine particles to the toner base particles and the crystallization of the crystalline resin are promoted irrespective of a difference in the uneven state of the surface of the toner base particles, so that the crystallinity of the entire toner can be uniformly increased.

The first mixing process is a process of mainly performing crushing of the inorganic fine particles and uniform sticking of the inorganic fine particles to the toner base particles. The first mixing process has a feature of performing the mixing processing at a temperature equal to or higher than the glass transition point of the toner base particles while imparting stirring power which allows crushing the inorganic fine particles and sticking the inorganic fine particles to the toner base particles in which the amorphous resin and the crystalline resin are dissolved.

The second mixing process is a process of mainly performing the fixation of the inorganic fine particles to the toner base particles simultaneous with the promotion of the crystallization of the crystalline resin in the mixture. The second mixing process is suitably performed at a temperature higher than the temperature of the first mixing process. The inorganic fine particles can be fixed by promoting the crystallization of the crystalline resin of the toner base particles to reduce a dissolved portion of the amorphous resin and the crystalline resin to thereby increase Tg of the toner base particles, i.e., by harden the toner base particles.

Both the first mixing process and the second mixing process can uniformize the heat transmitting manner from the container to the toner by imparting stirring power, and therefore can promote the crystallization of the crystalline resin and can uniformly increase the crystallinity of the entire toner.

Hereinafter, the toner manufacturing method of the present invention is specifically described.

### First Mixing Process

The first mixing process of the present invention is a process of mainly performing crushing of the inorganic fine particles and uniform sticking of the inorganic fine particles to the toner base particles. Therefore, in the first mixing process, the mixing is performed under the conditions of the processing temperature T₁ (° C.) and the stirring power W₁ (W/kg) represented by the following expression (1) and (4).

TgA≦T₁≦Tp (1)

W₂≦½W₁ (4)

The processing temperature T₁ in Expression (1) shows the temperature in the container of the mixing device. TgA (° C.) shows the glass transition temperature in a second temperature rise measured when the temperature is raised from 20° C. to 180° C. at a temperature rise rate of 10° C./min, the temperature is reduced to 20° C. at a temperature decrease rate of 50° C./min, the temperature is held at 20° C. for 10 minutes, and then the temperature is raised from 20° C. to 180° C. at a temperature rise rate of 10° C./min in the DSC measurement in which the toner base particles are measurement specimens. Tp (° C.) shows the onset temperature of the maximum endothermic peak derived from the crystalline resin measured when the temperature is raised from 20° C. to 180° C. at a temperature rise rate of 10/min in the DSC measurement in which the toner base particles are measurement specimens.

From the viewpoint of uniformly sticking the inorganic fine particles to the surface of the toner base particles, the processing temperature T₁ is in the range of Expression (1). TgA shows the glass transition temperature of the toner base particles in the dissolution of the crystalline resin and the amorphous resin. The movement of the molecules on the surface of the toner base particles is facilitated by externally adding the inorganic fine particles while setting the temperature in the container to a temperature equal to or higher than TgA. Thus, the surface of the toner base particles is softened, so that the inorganic fine particles can be uniformly stuck to the surface of toner base particles.

When T₁ is less than TgA, the molecules on the surface of the toner base particles are difficult to move. Therefore, the inorganic fine particles are difficult to be buried in the toner base particles. As a result, the inorganic fine particles move to the recesses of the toner base particles in the stirring and mixing, and then the amount of the inorganic fine particles in the protrusions of the toner base particles decreases, so that the transferability of the toner decreases in image formation. Moreover, since the buried degree of the inorganic fine particles is low in the stirring and mixing, the sticking of the inorganic fine particles to the toner base particles is weak. Therefore, particularly in low printing durability under a severe environment of low humidity and low temperature, the inorganic fine particles are detached due to stress in a development device to contaminate members of the development device.

On the other hand, when T₁ is Tp or higher, the crystalline resin dissolves. Therefore, the toner base particles are aggregated when externally adding the inorganic fine particles.

From the viewpoint of low-temperature fixability, TgA is suitably 55° C. or less and more suitably 50° C. or less. From the viewpoint of heat-resistant storageability and low-temperature fixability, Tp is suitably 45° C. or higher and 110° C. or less and more suitably 50° C. or higher and 100° C. or less.

W₁ in Expression (4) shows the stirring power per unit mass of the toner base particles in the stirring and mixing. The stirring power W₁ is suitably power of uniformly sticking the inorganic fine particles to the surface of the toner base particles irrespective of a difference in the uneven state of the surface of the toner base particles simultaneously with the crushing of the inorganic fine particles when the surface of the toner base particles is soft at the processing temperature T₁.

### Second Mixing Process

In the second mixing process, fixation of the inorganic fine particles to the toner base particles is performed simultaneous with promotion of the crystallization of the crystalline resin in the mixture. Therefore, the mixing is performed under the conditions of the processing temperature T₂ (° C.) and the stirring power W₂ (W/kg) represented by the following expression (2), (3), and (4).

TgA≦T₂≦Tp (2)

3≦W₂ (3)

W₂≦½W₁ (4)

The processing temperature T₂ in Expression (2) shows the temperature in the container of the mixing device. The processing temperature T₂ is in the temperature range of Expression (2) from the viewpoint of promoting the crystallization of the crystalline resin. When the processing temperature T₂ is higher, the movement of the molecules of the crystalline resin dissolved with the amorphous resin is facilitated, and therefore the crystallization of the crystalline resin is promoted. When T₂ is less than TgA, the movement of the molecules of the crystalline resin is slow. Therefore, the crystallization becomes insufficient, so that the heat-resistant storageability of the toner decreases. Furthermore, due to the presence of a dissolved portion of the crystalline resin and the amorphous resin, the fixation of the inorganic fine particles which are stuck to the toner base particles in the first mixing process becomes weak. As a result, in image formation, particularly, in low printing durability under a severe environment of low humidity and low temperature, the inorganic fine particles are buried into the toner base particles due to stress in a development device, so that the transferability of the toner decreases.

On the other hand, when T₂ is Tp or higher, the crystalline resin dissolves. Therefore, the toner base particles are aggregated when externally adding the inorganic fine particles.

W₂ in Expression (3) shows the stirring power per unit mass of the toner base particles in the stirring and mixing. The stirring power W₂ correlates with the movement of the toner base particles in the mixing device. The number of times of contact between the toner base particles and the container (heat source) increases by moving the toner base particles by stirring in the mixing device, so that heat can be uniformly transmitted to the toner base particles. As a result, the crystallinity of the entire toner base particle can be uniformly increased. W₂ needs to be 3 (W/kg) or more, suitably 5 (W/kg) or more, and more suitably 10 (W/kg) or more.

When the stirring power W₂ is less than 3 (W/kg), some toner base particles cannot contact the container (heat source). Therefore, the heat transmitting manner to the toner base particles becomes nonuniform, so that the toner base particles in which the crystallization of the crystalline resin is insufficient are present. More specifically, the crystallinity varies among the toner base particles. As a result, the heat-resistant storageability of the manufactured toner decreases.

Expression (4) shows the relationship between the stirring power W₁ and the stirring power W₂. In the second mixing process, W₂ is suitably ½ of W₁ or less in order to prevent excessive burying of the inorganic fine particles into the toner base particles. W₂ is more suitably ⅓ of W₁ or less. When W₂ is larger than ½W₁, the inorganic fine particles uniformly stuck to the surface of the toner base particles in the first mixing process are excessively buried into the toner base particles in the second mixing process. More specifically, the addition effect of the inorganic fine particles is lost and the transferability of the toner decreases in image formation.

In the second mixing process, it is more suitable for the processing temperature T₂ (° C.) to satisfy the following expression (5) from the viewpoint of promoting the crystallization of the crystalline resin.

T₁+5<T₂ (5)

Furthermore, due to the fact that the following expression (6) is satisfied in the first mixing process, the uniform sticking of the inorganic fine particles to the toner base particle surface simultaneous with the crushing of the inorganic fine particles becomes better. Specifically, by crushing the inorganic fine particles to almost the primary particles, the coverage of the inorganic fine particles on the surface of the toner base particles can be increased. Furthermore, by burying the inorganic fine particles in the soft state before the crystalline resin of the toner base particles is crystallized simultaneous with the crushing of the inorganic fine particles, the inorganic fine particles can be uniformly stuck while being hardly affected by the surface unevenness of the toner base particles. Therefore, the transferability of the toner further improves in image formation. W₁ is more suitably 50 or more.

30≦W₁ (6)

### Method for Manufacturing Toner Base Particles

A method for manufacturing toner base particles of the present invention is not particularly limited and is suitably a pulverization method in terms of the fact that toner excellent in low-temperature fixability is obtained.

Hereinafter, a method for obtaining toner base particles to be used in the present invention by a pulverization method is described. In a raw material mixing process, predetermined amounts of crystalline resin, amorphous resin, wax, colorant, other additives, and the like as materials constituting the toner base particles are weighed, and then blended and mixed. Examples of a mixing device include a double cone mixer, a V type mixer, a drum type mixer, a super mixer, a Henschel mixer, a Nauta mixer, and Mechano Hybrid (manufactured by NIPPON COKE & ENGINEERING. CO., LTD.), and the like.

Next, the mixed materials are melted and kneaded to disperse the crystalline resin, wax, colorant, and the like in the amorphous resin. In the melting and kneading process, a batch type kneader, such as a pressurization kneader and a Bambari mixer, and a consecutive kneader can be used. From an advantage that consecutive production can be realized, a uniaxial or biaxial extruder is mainly used. For example, a KTK type biaxial extruder (manufactured by KOBE STEEL., LTD.), a TEM type biaxial extruder (manufactured by TOSHIBA MACHINE CO., LTD.), a PCM type extruder (manufactured by Ikegai Iron Works, Ltd.), a biaxial extruder (manufactured by KCK), a co-kneader (manufactured by BUSS Inc.), a KNEADEX (manufactured by NIPPON COKE & ENGINEERING. CO., LTD.), and the like are mentioned. A resin composition obtained by the melting and kneading may be rolled with two rolls or the like, and then cooled with water or the like in a cooling process.

Subsequently, the cooled resin composition is pulverized up to a desired particle diameter in a pulverization process. In the pulverization process, the cooled resin composition is roughly pulverized by a pulverizer, such as a crusher, a hammer mill, and a feather mill, for example, and then further pulverized by a Kryptron system (manufactured by Kawasaki Heavy Industries, Ltd.), a super rotor (manufactured by Nisshin Engineering Co., Ltd), a turbo mill (manufactured by Turbo Co., Ltd.), or a pulverizer employing an air jet system. Then, the pulverized substances are classified using a classifier or a sieving device, such as an elbow jet employing an inertial classification system (manufactured by Nittetsu Mining Co., Ltd.), a Turboplex employing a centrifugal classification system (manufactured by HOSOKAWA MICRON CORP.), a TSP separator (manufactured by HOSOKAWA MICRON CORP.), and a Faculty (manufactured by HOSOKAWA MICRON CORP.), as required, to thereby obtain toner base particles.

After the pulverization, surface treatment, such as spheronization treatment, is performed as required using a hybridization system (manufactured by Nara Machinery Co., Ltd.), a mechanofusion system (manufactured by HOSOKAWA MICRON CORP.), a faculty (manufactured by HOSOKAWA MICRON CORP.), a meteor rainbow MR Type (manufactured by Nippon Pneumatic Mfg. Co., Ltd.), whereby the toner base particles can also be obtained.

In the toner manufacturing method of the present invention, the mixing at the specific processing temperature and with the specific stirring power as described above is performed in at least two stages of the first mixing process and the second mixing process. The mixing device has a “stirring unit” which imparts mechanical impact force” in a container. Examples of the mixing device include a Henschel mixer (manufactured by Mitsui Mining Co., Ltd.), a Nobilta (manufactured by HOSOKAWA MICRON CORP.), a hybridizer (manufactured by Nara Machinery Co., Ltd.), a cyclomix (manufactured by HOSOKAWA MICRON CORP.), and the like.

In the mixing, it is suitable to apply mechanical impact force. The “mechanical impact force” is power applied between a stirring unit of the mixing device and the bottom or the wall surface of the container, for example.

The processing temperature T₁ of the first mixing process (° C.) and the processing temperature T₂ in the second mixing process (° C.) can be controlled by passing water adjusted to a predetermined temperature into a jacket of the mixing device, introducing hot wind adjusted to a predetermined temperature into the mixing device, and the like, for example.

The stirring power W₁ (W/kg) of the mixing device to be imparted to the unit mass of a coated material in the first mixing process and the stirring power W₂ (W/kg) of the mixing device imparted to the unit mass of the coated material in the second mixing process are determined by the following expressions.

W₁=(E₁−E₁₀)/(Y₁×Y₁) (9)

W₂=(E₂−E₂₀)/(Y₂×Y₂) (10)

E₁: Consumption energy of mixer in mixing of coated material of first process [W·h]
E₁₀: Consumption energy in idling of first process [W·h]
X₁: Mixing time period of first process [h]
Y₁: Charged amount of coated material of first process [kg]
E₂: Consumption energy of mixer in mixing of coated material of second process [W·h]
E₂₀: Consumption energy in idling of second process [W·h]
X₂: Mixing time period of second process [h]
Y₂: Charged amount of coated material of second process [kg]

The mixing time period X₁ of the first mixing process is suitably 2 minutes or more from the viewpoint of crushing inorganic fine particles, and then sticking the inorganic fine particles to the surface of the toner base particles. The mixing time period is suitably 30 minutes or less from the viewpoint of suppressing the movement of the inorganic fine particles in the protrusions of the surface of the toner base particles to the recesses of the surface to uniformly stick the inorganic fine particles to the surface of the toner base particles.

The time period X₂ of the second mixing process is suitably 3 minutes or more from the viewpoint of uniformly increasing the crystallinity of the entire toner. The time period is suitably 50 minutes or less from the viewpoint of preventing excessive burying of the inorganic fine particles fixed to the surface of the toner base particles into the toner base particles, and then fixing the inorganic fine particles to the surface of the toner base particles in the first process.

After the second mixing process, desired inorganic fine particles may be newly added, and then external addition may be performed by a mixer, such as a Henschel mixer, as required.

### Configuration of Toner Base Particles

Next, the configuration of the toner base particles is described in detail. The toner base particles to be used in the present invention contain crystalline resin. By blending the crystalline resin, the toner to be obtained demonstrates outstanding low-temperature fixability. The melting point “Tcm” of the crystalline resin is suitably 120° C. or less from the viewpoint of the low-temperature fixability of the toner. The melting point of the crystalline resin is suitably 55° C. or higher from the viewpoint of heat-resistant storageability.

“TgB-TgA” in the following expression (7) shows a difference between the glass transition temperature TgA (° C.) in a state where the crystalline resin and the amorphous resin are dissolved and the glass transition temperature TgB (° C.) after the particles in the state where the crystalline resin and the amorphous resin are dissolved are allowed to stand at 50° C. for 20 minutes, and then the crystallization thereof is promoted. More specifically, a larger “TgA-TgB” value means that the crystallization rate of the crystalline resin is higher. The “TgA-TgB” value is suitably 5° C. or higher and more suitably 6° C. or higher.

TgB−TgA≧5 (7)

When the crystallization rate of the crystalline resin is high, the crystallization time period in the second mixing process can be shortened. Therefore, excessive burying of the inorganic fine particles uniformly stuck to the surface of the toner base particles in the first mixing process into the toner base particles is prevented, so that the inorganic fine particles can be uniformly fixed to the surface of the toner base particles.

Next, a technique for increasing the crystallization rate of the crystalline resin is described. In order to increase the crystallization rate of the crystalline resin, it is suitable to use a hydrocarbon wax as the wax. Although the mechanism is not clear, the present inventors consider that the wax functions as a nucleating agent. When toner is dissolved in fixing of the toner, and then the toner is cooled after the fixation of the toner, the wax is first crystallized in a high crystalline portion. It is considered that this crystallized wax functions as a crystal nucleating agent to promote the crystallization of the crystalline resin. In particular, when the melting point “Twm” of the wax is higher than the melting point Tcm of the crystalline resin, the wax is first crystallized, and then the crystalline resin is crystallized. Therefore, the crystallization rate of the crystalline resin becomes still higher. When a difference in the melting point between the crystalline resin and the wax is less than 20° C., the crystallization of the wax and the solidification of the crystalline resin simultaneously occur and therefore the crystallization of the crystalline resin more efficiently proceeds.

It is more suitable for the crystalline resin to have a crystal nucleating agent portion. When the crystalline resin has the crystal nucleating agent portion, the crystalline resin can be promptly crystallized from the nucleating agent portion.

Furthermore, the crystallization rate of the crystalline resin can also be increased by reducing the molecular weight of the crystalline resin. By reducing the molecular weight of the crystalline resin, the molecular mobility of the crystalline resin increases and the molecules are promptly oriented, so that the crystallization rate increases. The weight average molecular weight Mw of the crystalline resin is suitably 100,000 or less and more suitably 45,000 or less.

As described above, there are a large number of techniques for increasing the crystallization rate of the crystalline resin. The present inventors have found that it is effective to satisfy the expression (7) irrespective of the presence or absence of any one of these techniques or a combination of some of these techniques.

### Crystalline Resin

The crystalline resin is not particularly limited in the form and is suitably crystalline polyester from the viewpoint of obtaining toner excellent in low-temperature fixability. As the crystalline polyester, the following substances are specifically mentioned.

As alcohol components for use in raw material monomers of the crystalline polyester, aliphatic diols having 6 to 18 carbon atoms are suitable from the viewpoint of increasing the crystallinity. Among the above, aliphatic diols having 6 to 12 carbon atoms are suitable from the viewpoint of the fixability and the heat-resistant stability of toner. Examples of the aliphatic diols include 1,6-hexanediol, 1,7-heptanediol, 1,8-octanediol, 1,9-nonanediol, 1,10-decanediol, 1,11-undecanediol, 1,12-dodecanediol, and the like. The aliphatic diol is suitably contained in a proportion of 80.0 to 100.0% by mol in the alcohol component from the viewpoint of further increasing the crystallinity of the crystalline polyester.

As the alcohol component for obtaining the crystalline polyester, polyvalent alcohol components other than the aliphatic diols mentioned above may be contained and, for example, the following substances are mentioned. Mentioned are aromatic diols, such as an alkylene oxide adduct of bisphenol A represented by the following chemical formula (I) including a polyoxypropylene adduct of 2,2-bis(4-hydroxyphenyl)propane, a polyoxyethylene adduct of 2,2-bis(4-hydroxyphenyl)propane, and the like; and alcohols of trivalent or more, such as glycerol, pentaerythritol, and trimethylol propane.

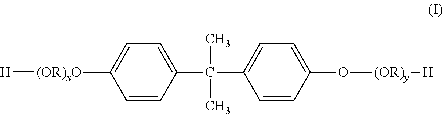

In the formula, R represents an alkylene group having 2 or 3 carbon atoms. x and y represent an integer of 0 or more and the sum of x and y is 1 to 16 and suitably 2 to 5.

As carboxylic acid components for use in the raw material monomers of the crystalline polyester, aliphatic dicarboxylic acid compounds having 6 to 18 carbon atoms are suitable. Among the above, aliphatic dicarboxylic acid compounds having 6 to 12 carbon atoms from are suitable from the viewpoint of the fixability and the heat-resistant stability of toner. Examples of the aliphatic dicarboxylic acid compounds include 1,8-octanedioic acid, 1,9-nonanedioic acid, 1,10-decanedioic acid, 1,11-undecanedioic acid, 1,12-dodecanedioic acid, and the like. The aliphatic dicarboxylic acid compounds having 6 to 18 carbon atoms are suitably contained in a proportion of 80.0 to 100.0% by mol in the carboxylic acid component.

As the carboxylic acid component for obtaining the crystalline polyester, carboxylic acid components other than the aliphatic dicarboxylic acid compounds mentioned above may be contained. For example, aromatic dicarboxylic acid compounds, aromatic polyvalent carboxylic acid compounds of trivalent or more, and the like are mentioned but the carboxylic acid component is not particularly limited thereto. The aromatic dicarboxylic acid compounds also include aromatic dicarboxylic acid derivatives. As a specific example of the aromatic dicarboxylic acid compounds, aromatic dicarboxylic acids, such as phthalic acid, isophthalic acid, and terephthalic acid, anhydrides of the acids, and alkyl (1 to 3 carbon atoms) esters of the acids are suitably mentioned. Examples of alkyl groups in the alkyl esters include a methyl group, an ethyl group, a propyl group, and an isopropyl group. Examples of the polyvalent carboxylic acid compounds of trivalent or more include aromatic carboxylic acids, such as 1,2,4-benzene tricarboxylic acid (trimellitic acid), 2,5,7-naphthalene tricarboxylic acid, and pyromellitic acid, and derivatives, such as anhydrides of the acids and alkyl (1 to 3 carbon atoms) esters of the acids.

The molar ratio (Carboxylic acid component/Alcohol component) of the alcohol component and the carboxylic acid component which are the raw material monomers of the crystalline polyester is suitably 0.80 or more and 1.20 or less.

The weight average molecular weight Mw of the crystalline polyester is suitably 8000 or more and 100,000 or less and more suitably 12,000 or more and 45,000 or less in order to increase the dissolution rate, the crystallization rate, and the heat-resistant storageability.

It is more suitable for the crystalline polyester to have a crystal nucleating agent portion because the crystallization rate of the crystalline polyester can be increased. Raw materials forming the crystal nucleating agent portion are not particularly limited insofar as the raw materials are compounds having a crystallization rate higher than that of crystalline polyester (hereinafter referred to as “resin P”) before the crystal nucleating agent portion is introduced. However, the raw materials forming the crystal nucleating agent portion are suitably compounds in which the main chain contains a straight-chain hydrocarbon portion and which has a functional group of monovalent or more capable of reacting with the molecular chain end of the “resin P” from the viewpoint that the crystallization rate is high.

Among the above, the raw materials forming the crystal nucleating agent portion are suitably aliphatic monoalcohols having carbon atoms of 10 or more and 30 or less or aliphatic monocarboxylic acids having carbon atoms of 11 or more and 31 or less from the viewpoint of increasing the long-term storage stability of toner. More specifically, the crystal nucleating agent portion suitably has a structure in which the aliphatic monoalcohol and/or the aliphatic monocarboxylic acid are/is condensed with the end of the crystalline polyester in the crystalline polyester. Examples of the aliphatic monoalcohols include 1-decanol, stearyl alcohol, and behenyl alcohol. Examples of the aliphatic monocarboxylic acids include stearic acid, arachidic acid, and behenic acid.

The molecular weight of the crystal nucleating agent portion is suitably 100 or more and 10,000 or less and more suitably 150 or more and 5,000 or less in terms of the fact that the reactivity of the molecular chain end of the crystalline polyester increases.

The crystal nucleating agent portion is suitably contained in a proportion of suitably 0.1% by mol or more and 7.0% by mol or less and more suitably 0.5% by mol or more and 4.0% by mol or less in monomers constituting the crystalline polyester from the viewpoint of increasing the crystallization rate.

A method for determining whether or not the crystal nucleating agent portion is bonded to the crystalline polyester is described later.

Next, it is suitable that a SP value (SPa) of the crystalline resin and a SP value (SPb) of the amorphous resin satisfy the following expression (8) from the viewpoint of the low-temperature fixability of toner.

−1.5≦SPb−Spa≦1.5 (8)

The SP value (solubility parameter) is used as an index which shows the ease of mixing of each resin, the ease of mixing of resin and wax, and the like. A value of “SPb−SPa” is an index which shows the ease of dissolution of the crystalline resin and the amorphous resin in heat melting. By controlling the SP value of each resin in this range, the dissolution rate of the crystalline resin in the amorphous resin becomes high and a Tg reduction in the fixation of toner becomes large, so that the low-temperature fixability of toner improves.

The SP value as used in the present invention is a solubility parameter δ calculated according to the following equation (1) shown by Toshinao Okitsu in “Secchaku (Adhesion) (Vol. 40, No. 8 (1996), pp. 342 to 350; published by Kobunshi Kankokai)”.

δ=ΣΔF/ΣΔv (1)

In Equation (1), ΔF represents a molar attraction constant of each atomic group and Σv represents a molar volume (volume per mole) of each atomic group. Specific values thereof are as shown in the following table.

When calculating the SP value of a mixture (mixed solvent and the like), the SP value can be determined by calculating the product of a solubility parameter and a molar fraction of each component, and then summing the products. Specifically, the SP value is calculated according to Equation (2).

δₘᵢₓ=φ₁δ₁+φ₂δ₂+ . . . +φₙδₙ (2)

In Equation (2), φₙ represents the molar fraction of the n-th component and δₙ represents the solubility parameter of the n-th component, and φ₁+φ₂+ . . . φₙ=1 is established.

| Atomic Group | ΔF | Δv | Atomic Group | ΔF | Δv | Atomic Group | ΔF | Δv |
|---|---|---|---|---|---|---|---|---|
| —CH3 | 205 | 31.8 | —OH (Diol) | 270 | 12 | —SH | 310 | 28 |
| —CH2— | 132 | 16.5 | —OH (Arom) | 238 | 12 | >SO2 | 675 | 11.4 |
| >CH— | 28.6 | −1 | —NH2 | 273 | 16.5 | >S═0 | 485 | 11.4 |
| >CH— (Poly) | 28.6 | 1.9 | —NH2 (Arom) | 238 | 21 | —S— | 201 | 12 |
| >C< | −81 | 14.8 | —NH— | 180 | 8.5 | S═ | 201 | 23 |
| >C<(Poly) | −81 | 19.2 | —NH—(Link) | 180 | 4 | SO3 | 322 | 27.5 |
| CH2═ | 195 | 31 | —N< | 61 | −9 | SO4 | 465 | 31.8 |
| —CH═ | 116 | 13.7 | —N═ | 118 | 5 | >Si< | 16.3 | 0 |
| >CH═ | 24.2 | −2.4 | —N═(Link) | 118 | 15 | PO4 | 374 | 28 |
| ═CH═ | 200 | 25 | —CN | 420 | 23 | H | 81 | 8 |
| —CH≡ | 100 | 6.5 | —CN (Arom) | 252 | 27 | —C6H5 (Arom) | 731 | 72 |
| —O— | 120 | 5.1 | —CN (Poly) | 420 | 27 | —C6H4 (Arom) | 655 | 62 |
| —O— (Arom,Lin) | 70 | 3.8 | —NO2 | 481 | 24 | —C6H3 (Arom) | 550 | 39 |
| —O— (Epoxy) | 176 | 5.1 | —NO2 (Arom) | 342 | 32 | —C6H2 (Arom) | 450 | 27 |
| —CO— | 286 | 10 | —NCO | 498 | 35 | —C6H5 (Poly) | 731 | 79 |
| —COOH— | 373 | 24.4 | —NHCO — | 690 | 18.5 | —C6H4 (Poly) | 655 | 69 |
| —COOH—(Arom) | 242 | 24.4 | >NHCO — | 441 | 5.4 | —C6H3 (Poly) | 550 | 47 |
| —COO— | 353 | 19.6 | —Cl (Mono) | 330 | 23 | —C6H2 (Poly) | 450 | 32 |
| —COO—(Poly) | 330 | 22 | —Cl (Di) | 250 | 25 | —(Cyclohexyl) | 790 | 97.5 |
| —O—CO —O— | 526 | 20 | —Cl (Tri,Tetra) | 235 | 27 | (Plus onto upper groups) | | |
| —CHO | 370 | 25 | —Cl (Arom) | 235 | 27 | 3 Member 1 in | +110 | +18 |
| —CHO (Arom) | 213 | 29 | —Cl (>C<) | 235 | 28 | 4 Member 1 in | +110 | +18 |
| —OH (Mono) | 395 | 10 | —Cl (Poly) | 270 | 27 | 5 Member 1 in | +110 | +16 |
| —OH (Ether) | 342 | 12 | —Br (mean) | 302 | 30 | 6 Member 1 in | +100 | +16 |
| —OH (H2O) | 342 | 12 | —F (mean) | 130 | 19 | Conjugated Double | +30 | −22 |
| —OH (Poly) | 282 | 17 | —F (Poly) | 110 | 21 | bond Ditto(Link) | +30 | −10 |

For example, the SP value of heptane is calculated as follows.

Heptane has two —CH₃ and five —CH₂— as an atomic group. When ΣΔF and ΣΔv are calculated based on the value of each atomic group shown in the table, the calculated result is as follows.

ΣΔF=205×2+132×5=1070

ΣΔv=31.8×2+16.5×5=146.1

Thus, the SP value is calculated as follows according to Expression (1).

ΣΔF/ΣΔv=1070/146.1=7.32

The SP value of the resin can be controlled by the type and the amount of the raw material monomers to be used in manufacturing of the resin. In order to increase the SP value of the resin, a monomer with a large SP value may be used, for example. On the other hand, in order to reduce the SP value of the resin, a monomer with a small SP value may be used, for example.

### Amorphous Resin

The form of the amorphous resin is not particularly limited and amorphous polyester is suitable from the viewpoint of obtaining toner excellent in low-temperature fixability. Specific examples of the amorphous polyester include the following substances.

As alcohol components to be used in the raw material monomers of the amorphous polyester, the following substances are mentioned. As divalent alcohol components, the following substances are mentioned. Mentioned are an alkylene oxide adduct of bisphenol A represented by Chemical Formula (I) above including a polyoxypropylene adduct of 2,2-bis(4-hydroxyphenyl)propane, a polyoxyethylene adduct of 2,2-bis(4-hydroxyphenyl)propane, and the like; ethylene glycol, 1,3-propylene glycol, neopentyl glycol, and the like. Examples of alcohol components of trivalent or more include sorbitol, pentaerythritol, dipentaerythritol, and the like. The divalent alcohol components and the polyvalent alcohol components of trivalent or more can be used singly or in combination of two or more kinds of the compounds.

Examples of carboxylic acid components to be used in the raw material monomers of the amorphous polyester include the following substances. Examples of the divalent carboxylic acid components include maleic acid, fumaric acid, phthalic acid, isophthalic acid, terephthalic acid, succinic acid, adipic acid, n-dodecenyl succinic acid, anhydrides of these acids, lower alkyl esters of these acids, and the like. Examples of the polyvalent carboxylic acid components of trivalent or more include 1,2,4-benzene tricarboxylic acid, 2,5,7-naphthalene tricarboxylic acid, pyromellitic acid, empol trimer acid, anhydrides of these acids, lower alkyl esters of these acids, and the like, for example.

The glass transition temperature “Tgnc” of the amorphous polyester is suitably 45° C. or higher and 75° C. or less from the viewpoint of the low-temperature fixability and the heat-resistant storageability of toner. The softening point of the amorphous polyester is suitably 80° C. or higher and 150° C. or less from the viewpoint of the low-temperature fixability of toner.

The weight average molecular weight Mw of the amorphous polyester is suitably 8,000 or more and 1,000,000 or less and more suitably 40,000 or more and 300,000 or less from the viewpoint of the low-temperature fixability and the heat-resistant storageability of toner.

The acid value of the amorphous polyester is suitably 2 mgKOH/g or more and 40 mgKOH/g or less from the viewpoint of the good charge properties of toner.

The mass ratio of the crystalline resin and the amorphous resin contained in toner is suitably 1:99 to 50:50 and more suitably 5:95 to 40:60 from the viewpoint of the low-temperature fixability of toner and the long-term storage stability of images.

### Wax

The toner base particles to be used in the present invention contain wax. By blending wax, the crystallization rate of the crystalline resin can be increased and good mold releasability can be imparted to toner. In order to increase the crystallization rate of the crystalline resin, the wax type is suitably a hydrocarbon wax and the melting point of the wax is suitably 120° C. or less and more suitably 100° C. or less. Furthermore, when the melting point of the wax is higher than the melting point of the crystalline resin and a difference therebetween is 20° C. or less, the crystallization can be further promoted. The melting point of the wax is suitably 60° C. or higher from the viewpoint of heat-resistant storageability.

The wax is suitably low molecular weight polyethylene, low molecular weight polypropylene, and hydrocarbon wax, such as microcrystalline wax and paraffin wax, are suitable from the viewpoint of ease of dispersion in the toner base particles and high mold releasability of toner. Two or more kinds of wax may be used as required. Specific examples of the wax include the following substances: Southall H1, H2, C80, and C77 (Trade name) of Schumann Southall and HNP-1, HNP-3, HNP-9, HNP-10, HNP-11, HNP-12, and HNP-51 (Trade name) of NIPPON SEIRO CO., LTD.

When manufacturing toner by a pulverization method, the wax is suitably added in melting and kneading. The wax may be added in manufacturing of the amorphous resin. The wax is suitably contained in a proportion of 1.0 part by mass or more and 20.0 parts by mass or less based on 100.0 parts by mass of the crystalline resin and the amorphous resin in total.

### Colorant

The colorant to be contained in the toner base particles to be used in the present invention is not particularly limited and known colorants can be used. Specifically, the following substances are mentioned. As the colorant, a pigment may be singly used. However, it is suitable to use a dye and a pigment in combination to increase the definition in terms of the image quality of full color images.

Examples of black colorants include carbon black; magnetic materials; and those whose color is adjusted to black using a yellow colorant, a magenta colorant, and a cyan colorant.

Examples of magenta toner coloring pigments include the following substances: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:1, 48:2, 48:3, 48:4, 48:5, 49, 50, 51, 52, 53, 54, 55, 57:1, 58, 60, 63, 64, 68, 81:1, 81:2, 81:3, 81:4, 81:5, 83, 87, 88, 89, 90, 112, 114, 122, 123, 146, 147, 150, 163, 184, 185, 202, 206, 207, 209, 238, 269, and 282; C.I. Pigment Violet 19; C.I. Vat Red 1, 2, 10, 13, 15, 23, 29, and 35.

Examples of magenta toner dyes include the following substances: oil soluble dyes, such as C.I. Solvent Red 1, 3, 8, 23, 24, 25, 27, 30, 49, 81, 82, 83, 84, 100, 109, and 121; C.I. Disperse Red 9; C.I. Solvent Violet 8, 13, 14, 21, and 27; and C.I. Disperse Violet 1 and basic dyes, such as C.I. Basic Red 1, 2, 9, 12, 13, 14, 15, 17, 18, 22, 23, 24, 27, 29, 32, 34, 35, 36, 37, 38, 39, and 40; and C.I. Basic Violet 1, 3, 7, 10, 14, 15, 21, 25, 26, 27, and 28.

Examples of cyan toner coloring pigments includes the following substances: C.I. Pigment Blue 2, 3, 15:3, 15:4, 16, and 17; C.I. Vat Blue 6; C.I. Acid Blue 45, and copper phthalocyanine pigments in which 1 to 5 phthalimidemethyl groups are replaced in the phthalocyanine skeleton.

Examples of cyan coloring dyes include C.I. Solvent Blue 70.

Examples of yellow coloring pigments include the following substances: C. I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, and 154, 155, 168, 174, 175, 176, 180, 181, and 185; and C.I. Vat Yellow 1, 3, and 20.

Examples of yellow coloring dyes include C.I. Solvent Yellow 162.

The used amount of the colorant is suitably 0.1 part by mass or more and 30 parts by mass or less and more suitably 0.5 part by mass or more and 20 parts by mass or less based on 100 parts by mass of the crystalline resin and the amorphous resin in total.

The toner of the present invention may be a magnetic toner. When using the toner of the present invention as a magnetic toner, magnetic iron oxide can be used as the magnetic material and the colorant. As the magnetic iron oxide, iron oxides, such as magnetite, maghematite, and ferrite, are used. The amount (as the colorant) of the magnetic iron oxide contained in the toner is suitably 25.0 parts by mass or more and 45.0 parts by mass or less based on 100.0 parts by mass of the crystalline resin and the amorphous resin in total. The amount is more suitably 30.0 parts by mass or more and 45.0 parts by mass or less.

### Inorganic Fine Particles

In the toner manufacturing method of the present invention, inorganic fine particles are mixed with the toner base particles. The inorganic fine particles have a function of increasing the flowability of toner, a function of equalizing the charge of toner, a function of increasing the transferability of toner, and the like. The number average particle diameter of primary particles of the inorganic fine particles is suitably 10 nm or more and 500 nm or less and more suitably 100 nm or more and 300 nm or less from the viewpoint of an increase in flowability and transferability of toner. In particular, according to the method of the present invention, 100 nm or more inorganic fine particle having a higher effect in the improvement of the transferability of toner can be uniformly fixed to the surface of the toner base particles irrespective of the uneven state of the surface of the toner base particles.

Examples of the inorganic fine particles include fine particles, such as silica fine particles, titanium oxide fine particles, alumina fine particles, or composite oxide particles thereof. Among the inorganic fine particles above, silica fine particles and titanium oxide particles are suitable.

Examples of the silica fine particles include dry silica or fumed silica generated by gaseous phase oxidization of silicon halide and wet silica produced from water glass. As the silica fine particles, dry silica in which the number of silanol groups present on the surface of and inside the silica fine particles is small and the content of Na₂O and SO₃²⁻ is small is suitable. The dry silica may be composite fine particles of silica and other metal oxides produced by the use of metal halogenated compounds, such as aluminum chloride and titanium chloride, with silicon halides in a manufacturing process.

By hydrophobization of the inorganic fine particles themselves, the adjustment of the charge amount of toner, the improvement of environmental stability, and the improvement of the properties under a high humidity environment can be achieved. Therefore, it is more suitable to use the hydrophobized inorganic fine particles as the inorganic fine particles. When the inorganic fine particles externally added to toner absorb moisture, the charge amount of the toner decreases, so that a reduction in the developability and the transferability is likely to occur.

Examples of treatment agents for the hydrophobization treatment of the inorganic fine particles include native silicone varnish, various kinds of denatured silicone varnish, native silicone oil, various kinds of denatured silicone oil, silane compounds, silane coupling agents, and other organosilicon compounds and organic titanium compounds. These treatment agents can be used singly or in combination of two or more kinds thereof. Among the above, inorganic fine particles treated with silicone oil are suitable. Hydrophobized inorganic fine particles treated by silicone oil simultaneously with or after the hydrophobization treatment of the inorganic fine particles with a coupling agent are more suitable from the viewpoint of maintaining a high charge amount of toner even under a high humidity environment and reducing selection developability.

The added amount of the inorganic fine particles is suitably 0.1 part by mass or more and 20.0 parts by mass or less and more suitably 0.5 part by mass or more and 8.0 parts by mass or less based on 100.0 parts by mass of the toner base particles.

To the toner base particles, other external additives may be added as required. For example, resin fine particles and inorganic fine particles which function as charging adjuvants, conductivity imparting agents, caking inhibitors, mold release agents in heat roller fixation, lubricants, and abrasives. Examples of the lubricants include polyethylene fluoride powder, zinc stearate powder, and polyvinylidene fluoride powder. Among the above, polyvinylidene fluoride powder is suitable. Examples of the abrasives include cerium oxide powder, silicon carbide powder, and strontium titanate powder.

### Magnetic Carrier

The toner to be manufactured by the present invention can be used as a one-component developing agent and can also be used as a two-component developing agent by being mixed with a magnetic carrier. As the magnetic carrier, known substances, such as a ferrite carrier and a magnetic material dispersion resin carrier (a so-called resin carrier) in which a magnetic material is dispersed in a binding resin, can be used. When the toner is mixed with a magnetic carrier to be used as a two-component developing agent, the toner concentration in the developing agent is suitably 2% by mass or more and 15% by mass or less.

In the toner to be manufactured by the present invention, the weight average particle diameter (D4) is suitably 3.0 μm or more and 8.0 μm or less and more suitably 5.0 μm or more and 7.0 μm or less. The use of the toner having such a weight average particle diameter (D4) is suitable in terms of improving the handling properties of the toner and satisfying the reproducibility of dots. The ratio “D4/D1” of the weight average particle diameter (D4) to the number average particle diameter (D1) of the toner is suitably 1.25 or less and more suitably 1.20 or less.

The average circularity of the toner is suitably 0.930 or more and 0.985 or less and more suitably 0.940 or more and 0.980 or less. The use of the toner of such an average circularity is suitable in terms of satisfying the uniform chargeability of the toner and the cleaning properties of untransferred toner.

### Measuring Method

A method for measuring each of the physical property values specified in the present invention is described below.

### 1. Measurement of Crystal Nucleating Agent Portion

2 mg of a sample is precisely weighed, and then 2 mL of chloroform is added for dissolution to produce a sample solution. As the resin sample, crystalline polyester is used but a toner containing crystalline polyester can be substituted as a sample. Next, 20 mg of 2,5-dihydroxybenzoic acid (DHBA) is precisely weighed, and then 1 mL of chloroform is added for dissolution to prepare a matrix solution. Separately, 3 mg of Na trifluoroacetate (NaTFA) is precisely weighed, and then 1 mL of acetone is added for dissolution to prepare an ionization assistant solution.

25 μL of the sample solution thus prepared, 50 μL of the matrix solution thus prepared, and 5 μL of the ionization assistant solution thus prepared are added dropwise onto a sample plate for MALDI analysis, and then dried to produce a measurement sample. MALDI-TOFMS (Reflex III, manufactured by Bruker DalTonics) is used as an analytical instrument to obtain a mass spectrum. In the obtained mass spectrum, each peak in the oligomer region (m/Z is 2000 or less) is attributed to confirm whether there is a peak corresponding to a structure in which the crystal nucleating agent is bonded to the molecular end.

### 2. Measurement of Glass Transition Temperature (Tgnc) of Amorphous Resin

The glass transition temperature Tg of the amorphous resin is calculated from the DSC curve measured according to ASTM D3418-82 using differential scanning calorimetric analysis device “Q2000” (manufactured by TA Instruments).

For the temperature correction of a device detecting unit, the melting point of indium and zinc is used. For the correction of the amount of heat, the heat of melting of indium is used. Specifically, about 2 mg of a specimen is precisely weighed, the weighed specimen is put in an aluminum pan, and then measurement is performed at a temperature rise rate of 10° C./min in a measurement temperature range of 20 to 180° C., while using an empty aluminum pan as a reference. In the measurement, the temperature is once raised to 180° C., the temperature is cooled to 20° C. at a temperature decrease rate of 50° C./min, and then the temperature is raised again. In this second temperature rise process, a specific heat change is detected in the DSC curve in a temperature range of 20 to 180° C. The intersection point of the line through the midpoint of the baseline before and after the occurrence of the specific heat change at this time and the differential thermal curve is defined as the glass transition temperature “Tgnc” of the amorphous resin.

### 3. Measurement of Glass Transition Temperature (Tg1st) of Toner

The Tg1st is calculated from the DSC curve measured according to ASTM D3418-82 using a differential scanning calorimetric analysis device “Q2000” (manufactured by TA Instruments). For the temperature correction of a device detecting unit, the melting point of indium and zinc is used. For the correction of the amount of heat, the heat of melting of indium is used. Specifically, about 2 mg of a specimen is precisely weighed, the weighed specimen is put in an aluminum pan, and then temperature rise measurement is performed at a temperature rise rate of 10° C./min in a measurement temperature range of 20 to 180° C., while using an empty aluminum pan as a reference.

In the temperature rise process, a specific heat change is detected in the DSC curve in a temperature range of 20 to 180° C. The intersection point of the line through the midpoint of the baseline before and after the occurrence of the specific heat change at this time and the differential thermal curve is used as the glass transition temperature in the first temperature rise “Tg1st” of toner.

### 4. Measurement of Glass Transition Temperature (TgA) of Toner Base Particles

The TgA is calculated from the DSC curve measured according to ASTM D3418-82 using a differential scanning calorimetric analysis device “Q2000” (manufactured by TA Instruments). For the temperature correction of a device detecting unit, the melting point of indium and zinc is used. For the correction of the amount of heat, the heat of melting of indium is used. Specifically, about 2 mg of a specimen is precisely weighed, the weighed specimen is put in an aluminum pan, and then a first temperature rise measurement is performed at a temperature rise rate of 10° C. in a measurement temperature range of 20 to 180° C., while using an empty aluminum pan as a reference. Subsequently, after the first temperature rise, the temperature is reduced to 20° C. at a temperature decrease rate of 50° C./min. Immediately after the cooling, the temperature is raised at a temperature rise rate of 10° C./min from 20° C. to 180° C., and then second temperature rise measurement is performed.

In the second temperature rise process, a specific heat change in the DSC curve in a temperature range of 20 to 180° C. is detected. The intersection point of the line through the midpoint of the baseline before and after the occurrence of the specific heat change and the differential thermal curve is used as the glass transition temperature in the second temperature rise “TgA” of toner base particles.

### 5. Measurement of Glass Transition Temperature TgB of Toner Base Particles

TgB is measured similarly as in the case of TgA, except the point that the cooling operation between after the first temperature rise and before the start of the second temperature rise in the DSC measurement is different from the cooling operation in the case of the TgA measurement method. More specifically, after the first temperature rise, the temperature is reduced to 50° C. at a temperature decrease rate of 50° C./min rate, the temperature is held at 50° C. for 20 minutes, the temperature is reduced to 20° C. at a temperature decrease rate of 50° C./min, the temperature is held at 20° C. for 10 minutes, and then the second temperature rise is started.

### 6. Measurement of Melting Point and Amount of Heat of Melting of Crystalline Resin and Wax

With respect to the melting point of crystalline resin and wax, in the DSC curve measured according to ASTM D3418-82 using a differential scanning calorimetric analysis device “Q2000” (manufactured by TA Instruments), the peak temperature of the maximum endothermic peak is defined as the melting point and the amount of heat calculated from the peak area is defined as the amount of heat of melting.

For the temperature correction of a device detecting unit, the melting point of indium and zinc is used. For the correction of the amount of heat, the heat of melting of indium is used. Specifically, about 2 mg of a specimen is precisely weighed, the weighed specimen is put in an aluminum pan, and then measurement is performed at a temperature rise rate of 10° C./min in a measurement temperature range of 30 to 180° C., while using an empty aluminum pan as a reference. In the measurement, the temperature is once raised to 180° C., the temperature is cooled to 30° C. at a temperature decrease rate of 50° C./min, and then the temperature is raised again. The maximum endothermic peak temperature in the DSC curve in the temperature range of 30 to 200° C. in this second temperature rise process is defined as the melting point and the amount of heat calculated from the peak area is defined as the amount of heat of melting.

7. Measurement of Onset Temperature Derived from Crystalline Resin in Toner Base Particles (Tp)

The onset temperature Tp derived from the crystalline resin in the toner base particles is measured under the following conditions using a differential scanning calorimetry device DSCQ2000 (manufactured by TA Instruments).

Temperature rise rate: 10° C./min

Measurement start temperature: 20° C.
Measurement end temperature: 180° C.

For the temperature correction of a device detecting unit, the melting point of indium and zinc is used. For the correction of the amount of heat, the heat of melting of indium is used. Specifically, about 5 mg of a specimen is precisely weighed, the weighed specimen is put in a silver pan, and then measurement is performed once. As a reference, an empty silver pan is used.

The measurement data obtained by the measurement are analyzed with software “TA Instruments Universal Analysis 2000” provided with the device, and then the onset temperature Tp of the maximum endothermic peak derived from the crystalline resin which can take a crystal structure is calculated. The maximum endothermic peak is a peak at which the endothermic amount reaches as the maximum when a plurality of endothermic peaks are present in the DSC chart. As a material which shows the endothermic peak in the toner base particles for use in the manufacturing method of the present invention, wax is mentioned in addition to the crystalline resin. However, the maximum endothermic peak can be specified to be derived from the crystalline resin from the content in the toner base particles.

The onset temperature Tp is a temperature which shows the intersection point of the straight line drawn by extending the baseline on the low temperature side of the DSC chart to the high temperature side and the tangential line drawn in such a manner that the gradient is the maximum on the curve which shows the change of the endothermic quantity in the temperature rise of the maximum endothermic peak as illustrated in FIGURE.

### 8. Measurement of Weight Average Molecular Weight by Gel Permeation Chromatography (GPC)

A column is stabilized in a 40° C. heat chamber, tetrahydrofuran (THF) is flown into the column at this temperature at a flow rate of 1 mL per minute as a solvent, about 100 μL of a THF specimen solution is poured, and then measurement is performed. In the molecular weight measurement of the specimen, the molecular weight distribution of the specimen is calculated from the relationship between the logarithmic value of a calibration curve created by several kinds of monodisperse polystyrene standard specimens and the count value. As a standard polystyrene specimen for the creation of the calibration curve, it is appropriate to use a standard polystyrene specimen with a molecular weight of about 10² to 10⁷ manufactured by TOSOH CORP. or Showa Denko K.K. and to use about at least ten standard polystyrene specimens, for example. As a detector, an RI (refractive index) detector is used. As the column, a plurality of commercially available polystyrene gel columns may be combined and, for example, the following combinations are mentioned. Mentioned are combinations of shodex GPC KF-801, 802, 803, 804, and 805, 806, 807, and 800P manufactured by Showa Denko K.K. and combinations of TSKgel G1000H (H_{XL}), G2000H (H_{XL}), G3000H (H_{XL}), G4000H (H_{XL}), G5000H (H_{XL}), G6000H (H_{XL}), G7000H (H_{XL}), and TSKgurd column manufactured by TOSOH CORP.

The specimen is produced as follows.

50 mg of a specimen is put in 10 mL of THF, allowed to stand at 25° C. for several hours, sufficiently shaken, sufficiently mixed with the THF (until an agglomerate of the specimen is lost), and then allowed to stand for 12 hours or more. In this process, the total time period in which the resultant substance is allowed to stand in the THF is set to 24 hours. Then, those which are passed through a sample treatment filter (One having a pore size of 0.2 μm or more and 0.5 μm or less, e.g., MAISHORI disk H-25-2 (manufactured by TOSOH CORP.), and the like, can be used.) are used as a GPC specimen. The specimen concentration is adjusted in such a manner that the resin component is 0.5 mg/mL or more and 5.0 mg/mL or less.

### 9. Measurement of Softening Point of Amorphous Resin and Toner

The measurement of the softening point of the amorphous resin and the toner is performed using a constant load extrusion type capillary rheometer “Flowability evaluation device Flow tester CFT-500D” (manufactured by Shimadzu Corp.) according to the manual provided with the device. With this device, a measurement specimen charged into a cylinder is melted by raising the temperature while applying a fixed load with a piston from the upper portion of the measurement specimen, and then the melted measurement specimen is taken out from a die at a bottom portion of the cylinder is extruded, whereby a flow curve which shows the relationship between the descent amount of the piston and the temperature in this operation can be obtained.

The “Melting temperature in the ½ method” described in the manual provided with the “Flowability evaluation device Flow tester CFT-500D” is defined as the softening point. The melting temperature in the ½ method is calculated as follows. First, a ½ value X of a difference between the piston descent amount Smax when the flow ends and the piston descent amount Smin when the flow starts is determined (X=(Smax−Smin)/2). Then, the temperature of the flow curve when the piston descent amount is given by “Smin+X” in the flow curve is the melting temperature in the ½ method.

Used as the measurement specimen is one obtained by pressing and molding about 1.0 g of a specimen under a 25° C. environment using a tablet molding press (for example, NT-100H, manufactured by NPA system Co., Ltd.) at about 10 MPa for about 60 seconds to form the specimen into a cylindrical shape with a diameter of about 8 mm.

The measurement conditions of CFT-500D are as follows.

Test mode: Temperature rise method
Temperature rise rate: 4° C./min
Start temperature: 50° C.
Reach temperature: 200° C.
Piston cross-sectional area: 1.000 cm²
Test load (Piston load): 10.0 kgf (0.9807 MPa)
Preheating time period: 300 seconds
Die opening diameter: 1.0 mm
Die length: 1.0 mm

### 10. Measurement of Weight Average Particle Diameter (D4) of Toner

The weight average particle diameter (D4) of the toner is calculated by performing measurement at the number of effective measuring channels of 25000 channels using a precision particle size distribution meter “Coulter counter Multisizer 3” (Registered Trademark, manufactured by Beckman Coulter) by an aperture impedance method having a 100 μm aperture tube and software provided with the meter for setting the measurement conditions and analyzing the measurement data “Beckman Coulter Multisizer 3 Version3.51” (manufactured by Beckman Coulter), and then analyzing the measurement data.

As an aqueous electrolyte solution to be used in the measurement, one prepared by dissolving special-grade sodium chloride in deionized water in such a manner that the concentration is adjusted to about 1% by mass, e.g., “ISOTON II” (manufactured by Beckman Coulter, Inc.), can be used.

The software is set as follows prior to the measurement and analysis.

In the “Screen of modifying the standard operating method (SOM)” in the software, the total count number in the control mode is set to 50000 particles. Then, the number of measurements is set to 1 time and the Kd value is set to a value obtained using “10.0 μm of standard particles” (manufactured by Beckman Coulter, Inc.). The threshold value and noise level are automatically set by pressing a “Threshold value/noise level measurement button”. The current is set to 1600 μA, the gain is set to 2, the electrolyte is set to ISOTON II, and then a check is entered for the aperture tube flush after the measurement.

In the “Screen of setting conversion from pulses to particle diameter” of the software, the bin interval is set to a logarithmic particle diameter, the particle diameter bin is set to 256 particle diameter bins, and the particle diameter range is set to 2 μm to 60 μm.

A specific measurement procedure is as described in the following items 1 to 7.

1. About 200 mL of the aqueous electrolyte solution is put in a 250 mL round bottom glass beaker intended for use with the Multisizer 3, the beaker is placed in a sample stand, and then counterclockwise stirring with a stirrer rod is carried out at 24 rotations per second. Contamination and air bubbles in the aperture tube are removed by the “Aperture flush” function of analysis software.

2. About 30 mL of the aqueous electrolyte solution is put in a 100 mL flat bottom glass beaker. About 0.3 mL of a dilution prepared by diluting “Contaminon N” (10% by mass aqueous solution of a neutral detergent for cleaning precision measurement instrument with a pH of 7 containing a nonionic surfactant, an anionic surfactant, and an organic builder, manufactured by Wako Pure Chemical Industries, Ltd.) by about 3 mass-times with deionized water is added as a dispersant.

3. A predetermined amount of deionized water is put in a water tank of an ultrasonic disperser “Ultrasonic Dispersion System Tetora 150” (manufactured by Nikkaki Bios Co., Ltd.) which has two oscillators with an oscillation frequency of 50 kHz disposed in such a manner that the phases are shifted by 180° and has an electrical output of 120 W, and then about 2 mL of Contaminon N is added into the water tank.

4. The beaker described in 2 above is set into a beaker holding opening of the ultrasonic disperser, and then the ultrasonic disperser is operated. The height of the beaker is adjusted in such a manner that the resonance condition of the liquid level of the aqueous electrolyte solution in the beaker reaches the maximum.

5. While the aqueous electrolyte solution in the beaker set as described in 4 above is irradiated with ultrasonic waves, about 10 mg of toner is added to the aqueous electrolyte solution in small portions to be dispersed. The ultrasonic dispersion treatment is further continued for 60 seconds. The water temperature in the water bath is controlled as appropriate during the ultrasonic dispersion to be 10° C. or higher and 40° C. or less.

6. The aqueous electrolyte solution in which the toner is dispersed as described in 5 above is added dropwise into the round bottom beaker set in the sample stand as described in 1 above using a pipette, and then adjusted in such a manner that the measurement concentration is about 5%. Then, measurement is performed until the number of measured particles reaches 50000.

7. The measurement data are analyzed by the software provided with the device, and then the weight average particle diameter of the toner (D4) is calculated. The “Average diameter” of an “Analysis/Volume statistical value (Arithmetic mean)” screen when set to Graph/Volume % by the software is the weight average particle diameter (D4).

11. Measurement of average circularity of toner

The average circularity of the toner particles is measured under measurement/analysis conditions in calibration with a flow type particle image analyzer “FPIA-3000” (manufactured by Sysmex Corp.).

A specific measurement method is as follows. To 20 mL of deionized water, an appropriate amount of a surfactant, suitably alkylbenzene sulfonate, is added as a dispersant, and then 0.02 g of the measurement specimen is added. Using a desktop ultrasonic cleaner/disperser having an oscillation frequency of 50 kHz and an electrical output of 150 W (e.g., “VS-150” manufactured by Velvo-Clear Co., Ltd.), dispersion is performed for 2 minutes to give a dispersion liquid for measurement. In this operation, cooling is performed as appropriate in such a manner that the temperature of the dispersion liquid is 10° C. or higher and 40° C. or less.

For the measurement, the flow-type particle image analyzer provided with a regular objective lens (10-fold magnification) is used. For a sheath solution, a Particle Sheath “PSE-900A” (manufactured by Sysmex Corporation) is used. The dispersion prepared according to the procedure described above is introduced into the flow-type particle image analyzer, and then 3000 toner particles are measured according to a total count mode in an HPF measurement mode. Then, a binarization threshold during the particle analysis is set to 85% and the analyzed particle diameter is limited to a circle-equivalent diameter of 2.00 μm or more and 200.00 μm or less, and then the average circularity of the toner is determined.

For the measurement, automatic focal point adjustment is performed before the start of the measurement using reference latex particles (e.g., diluting 5200A manufactured by Duke Scientific with deionized water). After the adjustment, focal point adjustment is suitably performed every 2 hours after the start of the measurement.

In the present invention, a flow-type particle image analyzer which has been calibrated by Sysmex Corporation and has been issued with a calibration certificate by Sysmex Corporation is used. The measurement is performed under the same measurement and analysis conditions as those when the calibration certificate has been received except limiting the analyzed particle diameter to a circle-equivalent diameter of 2.00 μm or more and 200.00 μm or less.

The measurement principle of the “FPIA-3000” flow-type particle image analyzer (manufactured by Sysmex Corporation) is taking flowing particles as a still image and performing image analysis. The specimen added into the specimen chamber is transmitted into a flat sheath flow cell by a specimen suction syringe. The specimen transmitted into the flat sheath flow is sandwiched by the sheath liquid to form a flat flow. The specimen passing through the flat sheath flow cell is irradiated with stroboscopic light at an interval of 1/60 seconds, which enables taking of the flowing particles as a still image. Moreover, since the flow is flat, the image is taken under in-focus conditions. The particle image is captured with a CCD camera. The taken image is subjected to image processing at an image processing resolution of 512×512 (0.37 μm×0.37 μm per pixel), contour definition of each particle image is performed, and then the projected area, the peripheral length, and the like of the particle image are measured.

Next, the projected area S and the peripheral length L of each particle image are determined. The circle-equivalent diameter and the circularity are determined using the area S and the peripheral length L. The circle-equivalent diameter is the diameter of a circle having the same area as the projected area of the particle image. The circularity is defined as a value obtained by dividing the peripheral length of the circle determined from the circle-equivalent diameter by the peripheral length of the projected image of the particles and is calculated using the following formula.

Circularity C=2×(π×S)^{1/2}/L (12)

The circularity is 1.000 when the particle image is a circle. When the circularity decreases with an increase in the degree of unevenness of the periphery of the particle image. After the circularity of each particle is calculated, the circularity range of 0.200 to 1.000 is divided into 800, and then the arithmetic average value of the obtained circularities is calculated to be used as the average circularity.

### Examples

Hereinafter, the present invention is described in more detail with reference to Examples. Prior to Examples, crystalline polyester resin manufacturing examples 1 to 4, amorphous polyester resin manufacturing examples 11 and 12, and toner base particle manufacturing examples 21 to 27 are described. In Examples and the like, “part(s)” and “%” are all based on mass unless otherwise specified.

### Manufacturing Example 1

Into a reaction vessel having a nitrogen introduction tube, a dehydrating tube, a stirrer, and a thermocouple, 1,10-decanediol as an alcohol monomer and 1,10-decane dioic acid as a carboxylic acid monomer were charged. Then, 1 part by mass of tin dioctylate was added as a catalyst based on the monomer total amount of 100 parts by mass, heated to 140° C. under a nitrogen atmosphere, and then reacted for 6 hours while distilling off water under normal pressure. Subsequently, the resultant substance was reacted while raising the temperature to 200° C. at 10° C./hour, reacted for 2 hours after the temperature reached 200° C., the pressure in the reaction vessel was reduced to 5 kPa or less, and then reacted at 200° C. for 3 hours. The resin is crystalline polyester before a crystal nucleating agent portion is introduced.

Thereafter, the pressure in the reaction vessel was gradually opened to be returned to normal pressure, a crystal nucleating agent (n-octadecanoic acid) of an amount shown in Table 1 was added, and then the resultant mixture was reacted at 200° C. under normal pressure for 2 hours. Then, the pressure in the reaction vessel was reduced to 5 kPa or less again, and then the resultant substance was reacted at 200° C. for 3 hours to give “crystalline polyester resin 1”. A peak having a structure in which n-octadecanoic acid was bonded to the molecular end of the crystalline polyester was confirmed in the mass spectrum of MALDI-TOFMS of the obtained resin. Therefore, it was confirmed that the molecular end of the crystalline polyester and the crystal nucleating agent were bonded to each other. The physical properties of the crystalline polyester resin 1 are shown in Table 2.

### Manufacturing Examples 2 to 4

Crystalline polyester resin 2 to crystalline polyester resin 4 were obtained in the same manner as in the manufacturing example 1, except changing a monomer, a crystal nucleating agent, and the used amount as shown in Table 1. In the mass spectrum of MALDI-TOFMS of the obtained crystalline polyester resin 2, a peak having a structure in which the crystal nucleating agent was bonded to the molecular end was confirmed. Therefore, it was confirmed that the molecular end and the crystal nucleating agent were bonded to each other. The physical properties of each resin are shown in Table 2.

TABLE 1

| | MONOMER STRUCTURE | | | | | | | | |
|---|---|---|---|---|---|---|---|---|---|
| | | | % | | | % | CRYSTAL | | % |
| | ALCOHOL | SP | by | ACID | SP | by | NUCLEATING | SP | by |
| | COMPONENT | VALUE | mol | COMPONENT | VALUE | mol | AGENT | VALUE | mol |
| CRYSTALLINE | 1,10- | 9.8 | 49.0 | 1,10- | 10.0 | 49.0 | n- | 8.40 | 2.0 |
| POLYESTER | DECANEDIOL | | | DECANEDIOIC | | | OCTADECANOIC | | |
| RESIN 1 | | | | ACID | | | ACID | | |
| CRYSTALLINE | 1,9- | 10.0 | 49.0 | 1,10- | 10.0 | 49.0 | n- | 8.40 | 2.0 |
| POLYESTER | NONANEDIOL | | | DECANEDIOIC | | | OCTADECANOIC | | |
| RESIN 2 | | | | ACID | | | ACID | | |
| CRYSTALLINE | 1,9- | 10.0 | 50.0 | 1,10- | 10.0 | 50.0 | | | |
| POLYESTER | NONANEDIOL | | | DECANEDIOIC | | | | | |
| RESIN 3 | | | | ACID | | | | | |
| CRYSTALLINE | 1,6- | 10.8 | 50.0 | FUMARIC ACID | 12.8 | 50.0 | | | |
| POLYESTER | HEXANEDIOL | | | | | | | | |
| RESIN 4 | | | | | | | | | |

TABLE 2

| | PHYSICAL PROPERTIES | | | |
|---|---|---|---|---|
| | | MELTING | ONSET TEMPERATURE | WEIGHT AVERAGE |
| | SP VALUE | POINT | Tp | MOLECULAR WEIGHT |
| | (cal/cm³)^{1/2} | ° C. | ° C. | — |
| CRYSTALLINE | 9.9 | 75.1 | 70.4 | 18500 |
| POLYESTER RESIN 1 | | | | |
| CRYSTALLINE | 10.0 | 70.4 | 68.5 | 23000 |
| POLYESTER RESIN 2 | | | | |
| CRYSTALLINE | 10.0 | 73.8 | 68.1 | 19000 |
| POLYESTER RESIN 3 | | | | |
| CRYSTALLINE | 11.8 | 75.3 | 71.9 | 17000 |
| POLYESTER RESIN 4 | | | | |

### Manufacturing Example 11

Into a reaction vessel having a nitrogen introduction tube, a dehydrating tube, a stirrer, and a thermocouple, monomers of the used amount shown in Table 3 were put, and then 1.5 parts by mass of dibutyl tin was added as a catalyst based on the monomer total amount of 100 parts by mass. Subsequently, the temperature was rapidly raised to 180° C. at normal pressure under a nitrogen atmosphere, water was distilled off while heating at a rate of 10° C./hour from 180° C. to 210° C., and then polycondensation was performed. After reaching 210° C., the pressure in the reaction vessel was reduced to 5 kPa or less, and then polycondensation was performed under the conditions of 210° C. and 5 kPa or less to give an amorphous polyester resin 11. In this operation, the polymerization time period was adjusted in such a manner that the softening point of the resin to be obtained has a value shown in Table 4. The physical properties of the amorphous polyester resin 11 are shown in Table 4.

### Manufacturing Example 12

An amorphous polyester resin 12 was obtained in the same manner as in Manufacturing Example 11, except changing monomers and the used amount as shown in Table 3. The physical properties of the resin are shown in Table 4.

TABLE 3

| | ACID (% by mol) | | | | ALCOHOL (% by mol) | |
|---|---|---|---|---|---|---|
| MONOMER TYPE | TPA | TMA | FA | DSA | BPA-PO | BPA-EO |
| SP VALUE | 10.28 | 11.37 | 12.83 | 9.33 | 9.51 | 9.74 |

| | | | | | | |
|---|---|---|---|---|---|---|
| AMORPHOUS POLYESTER 11 | 40.0 | 10.0 | 0.0 | 0.0 | 50.0 | 0.0 |
| AMORPHOUS POLYESTER 12 | 0.0 | 12.5 | 36.5 | 1.0 | 25.0 | 25.0 |

| | |
|---|---|
| TPA: TEREPHTHALIC ACID | BPA-PO: BISPHENOLA-PO 2 MOL ADDUCT |
| TMA: TRIMELLITIC ACID | BPA-EO: BISPHENOL A-EO 2 MOL ADDUCT |
| FA: FUMARIC ACID | PO: PROPYLENE OXIDE |
| DSA: DODECENYLSUCCINIC ACID | EO: ETHYLENE OXIDE |

TABLE 4

| | | WEIGHT | | |
|---|---|---|---|---|
| | | AVERAGE | | |
| | | MOLECULAR | | SOFTENING |
| | SP VALUE | WEIGHT | Tgnc | POINT |
| | (cal/cm³)^{1/2} | Mw | ° C. | ° C. |
| AMORPHOUS | 10.0 | 45000 | 58 | 118 |
| POLYESTER 11 | | | | |
| AMORPHOUS | 11.0 | 30000 | 58 | 135 |
| POLYESTER 12 | | | | |

### Manufacturing Example 21

Materials of types and amounts shown in the following table 5 were sufficiently mixed with a Henschel mixer (“FM-75” manufactured by Mitsui-Miike Mining Machinery Co, Ltd.), and then kneaded with a biaxial kneader (“PCM-30”, manufactured by Ikegai Iron Works, Ltd.) set to a temperature of 160° C. The obtained kneaded substance was cooled, and then coarsely pulverized to 1 mm or less with a hammermill to obtain coarsely pulverized substances.

Next, the coarsely pulverized substances were finely pulverized using a collision type air current pulverizer utilizing high-pressure gas. Next, the finely pulverized substances were classified using a wind power classifier (“Elbow jet labo EJ-L3”, manufactured by Nittetsu Mining Co., Ltd.) utilizing the Coanda effect to simultaneously remove fine powder and coarse powder to thereby obtain “toner base particles 1”.

TABLE 5

| | CRYSTALLINE | | AMORPHOUS | | | | | |
|---|---|---|---|---|---|---|---|---|
| | POLYESTER | | POLYESTER | | WAX | | | COLORANT* |
| TONER BASE | RESIN | | RESIN | | | MELTING | part by | part by |
| PARTICLES | No | part by weight | No | part by weight | TYPE | POINT | weight | weight |
| TONER BASE | 1 | 15.0 | 11 | 85.0 | PARAFFIN WAX | 78.2 | 5.0 | 5.0 |
| PARTICLES 1 | | | | | (NHP-9) | | | |
| TONER BASE | 2 | 15.0 | 11 | 85.0 | PARAFFIN WAX | 78.2 | 5.0 | 5.0 |
| PARTICLES 2 | | | | | (NHP-9) | | | |
| TONER BASE | 2 | 15.0 | 11 | 85.0 | FISCHER- | 92.4 | 5.0 | 5.0 |
| PARTICLES 3 | | | | | TROPSH WAX | | | |
| | | | | | (FNP-0090) | | | |
| TONER BASE | 3 | 15.0 | 11 | 85.0 | PARAFFIN WAX | 78.2 | 5.0 | 5.0 |
| PARTICLES 4 | | | | | (NHP-9) | | | |
| TONER BASE | 4 | 15.0 | 12 | 85.0 | CARNAUBA WAX | 82.0 | 5.0 | 5.0 |
| PARTICLES 5 | | | | | | | | |
| TONER BASE | 2 | 15.0 | 11 | 85.0 | PPWAX (NP-055) | 145.3 | 5.0 | 5.0 |
| PARTICLES 6 | | | | | | | | |

| | | |
|---|---|---|
| PARAFFIN WAX (NHP-9) | NIPPON SEIRO | *C.I. PIGMENT BLUE 15:3 |
| FISCHER-TROPSH WAX (FNP-0090) | CO., LTD. | |
| CARNAUBA WAX | NIPPON SEIRO | |
| PPWAX (NP-055) | CO., LTD. | |
| | S. KATO & CO. | |
| | MITSUI | |
| | CHEMICALS, INC. | |

### Manufacturing Examples 22 to 26

Toner base particles 2 to 6 were obtained in the same manner as in Manufacturing Example 21, except changing materials to be used to those in the configuration shown in Table 5 in Manufacturing Example 21.

### Manufacturing Example 27

Toner base particles 7 were obtained in the same manner as in Manufacturing Example 21, except changing materials to be used to those in the configuration shown in Table 6 in Manufacturing Example 21.

TABLE 6

| MATERIALS | part by weight |
|---|---|
| STYRENE-BUTYL ACRYLATE-MALEIC ACID- | 75.0 |
| DIVINYLBENZENE COPOLYMER | |
| AMORPHOUS POLYESTER 11 | 15.0 |
| CRYSTALLINE POLYESTER RESIN 4 | 10.0 |
| PARAFFIN WAX (HNP-9 NIPPON SEIRO CO., LTD.) | 5.0 |
| *C.I. PIGMENT BLUE 15:3 | 5.0 |

The physical properties of the obtained toner base particles 1 to 7 are shown in Table 9.

### Example 1

### 1. First Mixing Process

Materials shown in the following table 7 were charged into a Henschel mixer (FM-75, manufactured by Mitsui-Miike Mining Machinery Co, Ltd.). The preset temperature of water flowing into a jacket was adjusted in such a manner that the processing temperature T₁ was 50° C., the number of rotations was adjusted in such a manner that the stirring power W₁ was 140 W/kg, and then the materials were mixed for 5 minutes.

TABLE 7

| | USED AMOUNT | |
|---|---|---|
| MATERIALS | (part by weiqht) | (g) |
| TONER BASE PARTICLES 1 | 100.0 | 8000 |
| SILICA FINE PARTICLES | 5.0 | 400 |
| (HEXAMETHYLDISILAZANE [HMDS], | | |
| SURFACE TREATED WITH 5.0% by mol, | | |
| PRIMARY AVERAGE PARTICLE | | |
| DIAMETER OF 130 nm) | | |
| TITANIUM OXIDE FINE PARTICLES | 0.5 | 40 |
| (ISOBUTYLTRIMETHOXYSILANE, | | |
| SURFACE TREATED WITH 10.0% | | |
| by mol, PRIMARY AVERAGE PARTICLE | | |
| DIAMETER OF 30 nm) | | |

### 2. Second Mixing Process

After the end of the first mixing process, the preset temperature of water flowing into the jacket was adjusted in such a manner that the processing temperature T₂ was 60° C., the number of rotations was adjusted in such a manner that the stirring power W₂ was 10 W/kg, and then the materials were mixed for 15 minutes. After the second mixing process, the resultant substance was sieved through a mesh wire net with an opening of 75 μm to thereby obtain “toner 1”. The material configuration and manufacturing conditions of the toner 1 are shown in Table 10. The physical properties of the toner 1 are also shown in Table 11.

### 3. Manufacturing of Magnetic Carrier

Materials of the type and the amounts shown in the following table 8 were charged into a vessel, and then dried under reduced pressure at 75° C. for 5 hours while stirring and mixing by a solution decompression kneader to remove a solvent. Then, the resultant substance was baked at 135° C. for 2 hours, and then sieved through a sieve shaker (300MM-2, manufactured by TSUTSUI SCIENTIFIC INSTRUMENTS CO., LTD.: Opening of 75 μm) to thereby obtain a “magnetic carrier 1” with a D₅₀ of 40 μm.

TABLE 8

| MATERIALS | part by weight |
|---|---|
| Mn-Mg-FERRITE PARTICLES (50% PARTICLE | 100.0 |
| DIAMETER D₅₀ BASED ON VOLUME: 33 μm) | |
| SILICONE RESIN (MANUFACTURED BY SHIN- | 1.5 |
| ETSU CHEMICAL CO., LTD.: KR271) | |
| γ-AMINOPROPYLTRIETHOXYSILANE | 0.5 |
| TOLUENE | 98.0 |

### 4. Evaluation of Toner

The following evaluations 1 to 5 were performed using the toner 1. In each evaluation, good results were obtained. The evaluation results are shown in Table 12.

(Evaluation 1) Evaluation of Cohesiveness after Second Mixing Process

The toner after the second mixing process was sampled into a poly cup, and then visually evaluated. The evaluation results were ranked from A to D according to the following criteria.

A: No aggregate is observed and there are no problems.
B: Slight aggregation is observed but an aggregate is collapsed by lightly shaking the poly cup 5 times.
C: Aggregation is observed but an aggregate is easily broken with a finger.
D: Strong aggregation occurs.

### (Evaluation 2) Evaluation of Storage Stability

5 g of the toner was weighed into a poly cup with a capacity of 50 mL, and then allowed to stand in a 55° C. thermostat for 3 days. Then, the toner was taken out from the thermostat, the toner state was observed, and then the evaluation results were ranked from A to E according to the following criteria.

A: No aggregate is observed and the state is almost the same as the state in the early stage.
B: Slight aggregation is observed but an aggregate is collapsed by lightly shaking the poly cup 5 times.
C: Aggregation is observed but an aggregate is easily broken with a finger.
D: Strong aggregation occurs.
E: Toner is solidified.

### (Evaluation 3) Evaluation of Low-Temperature Fixability in High Speed Development

As an evaluation device, a commercially-available color laser printer Color Laser Jet CP4525 (manufactured by HP) was used. A fixing unit was removed from the evaluation device, and then an external fixing unit modified in such a manner that the fixing temperature, the fixing nip pressure, and the process speed of the fixing device can be arbitrarily set was attached in place of the removed fixing unit. As a recording medium, color laser copia paper (manufactured by CANON KABUSHIKI KAISHA, 80 g/m²) was used. Then, a toner product was removed from a commercial cyan cartridge, the inside was cleaned by air blow, and then 150 g of the toner 1 was charged. Separately, a toner product was removed from each station of magenta, yellow, and black, and then magenta, yellow, and black cartridges in which a toner residual amount detection mechanism was made unavailable were inserted thereinto.

Under an environment of a temperature of 23° C. and a relative humidity of 50%, an unfixed solid black image was output in such a manner that the toner bearing amount was 0.6 mg/cm². The unfixed solid black image was fixed by setting the fixing temperature of the fixing unit to 140° C. and the fixing nip pressure thereof to 0.10 MPa, and increasing the process speed in the range from 300 mm/sec to 500 mm/sec every 20 mm/sec. The obtained solid black image was rubbed back and forth 5 times with a lens-cleaning paper to which a load of about 100 g was applied. Then, the point where the density-decreasing rate of the image density before and after the rubbing was 10% or less was defined as the maximum process speed Vmax which enables fixation. A higher Vmax shows that the toner is more excellent in low-temperature fixability in high-speed development. The evaluation results were ranked from A to D according to the following criteria.

A (Very good): Vmax is 500 mm/sec.
B (Good): Vmax is 400 mm/sec or more and less than 500 mm/sec.
C (Average): Vmax is 300 mm/sec or more and less than 400 mm/sec.
D (Bad): Vmax is less than 300 mm/sec.
(Evaluation 4) Evaluation of Transferability in Early Stage and after Durability Test

A two-component developing agent was produced using the toner 1 and the magnetic carrier 1. In the two-component developing agent, 8.0 parts by mass of the toner was blended based on 100.0 parts by mass of the magnetic carrier and the toner 1 and the magnetic carrier 1 were mixed for 5 minutes with a V type mixer.

As an image forming device, a modified machine of a color copying machine image RUNNER iRC 3580 manufactured by CANON KABUSHIKI KAISHA was used. The machine was modified in such a manner that a developing agent-bearing member peripheral speed was set to 500 mm/sec and the photoconductor drum peripheral speed was set to 300 mm/sec. The two-component developing agent was charged into a cyan development device of the image forming device. Separately, a cyan bottle was removed, the inside was cleaned by air blow, and then the toner 1 was charged.

Using the modified machine, the electric potential contrast of the photoconductor was adjusted in such a manner that the bearing amount on the photoconductor was 0.3 mg/cm² under a low temperature and low humidity environment (temperature of 15° C., relative humidity of 10%).

The evaluation of the transferability in the early stage was performed by outputting a solid image, taping the untransferred toner on the photoconductor in the solid image formation by a Mylar tape, and then stripping the tape off. A density difference obtained by subtracting a density C₀ of one in which only the tape was stuck onto paper from a density C₁ of one in which the stripped-off tape was stuck onto paper was individually calculated. From the density difference value, judgment was performed as follows. The density was measured with a X-Rite color reflection densitometer (Color reflection densitometer X-Rite 404A).

The evaluation of the transferability after a durability test is evaluation performed after carrying out a durability test of performing printing of 50000 sheets with an image ratio of 1%. A solid image was output in the same manner as the evaluation of transferability in the early stage, the density C₁ and the density C₀ were measured, and then a density difference value was calculated.

The evaluation results were ranked from A to E according to the following criteria.

A: Density difference is less than 0.05.
B: Density difference is 0.05 or more and less than 0.10.
C: Density difference is 0.10 or more and less than 0.20.
D: Density difference is 0.20 or more and less than 0.30.
E: Density difference is 0.30 or more.

### (Evaluation 5) Evaluation of Contamination Properties of Charging Roller

This evaluation is evaluation utilizing a phenomenon in which when a charging roller is contaminated, the electrical resistance value becomes high and the charging current decreases.

As an image forming device, the same modified machine as that of the evaluation 4 was used. Under a low temperature and low humidity environment (temperature of 15° C., relative humidity of 10%), a direct-current voltage V_{DC} was adjusted in such a manner that the toner bearing amount in a solid portion on paper was 0.5 mg/cm². Then, a durability test of performing printing of 50000 sheets with an image ratio 1% was carried out. The charging alternating current value of the charging roller was measured by an application of a fixed alternating-current voltage before and after the durability test. Then, a current reduction amount was defined as the contamination properties, and the evaluation results were ranked from A to E according to the following criteria.

ΔA(Current reduction amount)=A₀(Early current value)−A₁(Current value after durability test)

A: Current reduction amount is less than 0.10 mA.
B: Current reduction amount is 0.10 mA or more and less than 0.20 mA.
C: Current reduction amount is 0.20 mA or more and less than 0.30 mA.
D: Current reduction amount is 0.30 mA or more and less than 0.40 mA.
E: Current reduction amount is 0.40 mA or more.

### Examples 2 to 31

The type and the used amount of the toner base particles and the silica fine particles, the conditions of the first mixing process, and the conditions of the second mixing process were changed as shown in Table 9. Toner 2 to toner 31 were obtained in the same manner as in Example 1 except the changes. The physical properties of each toner are shown in Table 11.

Evaluations 1 to 5 were performed in the same manner as in Example 1 except changing the toner type. For the evaluation requiring a two-component developing agent, a two-component developing agent was produced in the same manner as in Example 1. The evaluation results are shown in Table 12.

### Comparative Examples 1 and 2

Toner C1 and toner C2 were obtained using the same materials as those in Example 2, changing the mixing to single stage mixing of only the first mixing process, and changing the mixing conditions as shown in Table 9. The physical properties of each toner are shown in Table 11.

Evaluations 1 to 5 were performed in the same manner as in Example 1 except changing the toner type. For the evaluation requiring a two-component developing agent, a two-component developing agent was produced in the same manner as in Example 1. The evaluation results are shown in Table 12.

### Comparative Examples 3 to 9

The type and the used amount of the toner base particles and the silica fine particles, the conditions of the first mixing process, and the conditions of the second mixing process were changed as shown in Table 9. Toner C3 to toner C9 were obtained in the same manner as in Example 1 except the changes. The physical properties of each toner are shown in Table 11.

Evaluations 1 to 5 were performed in the same manner as in Example 1 except changing the toner type. For the evaluation requiring a two-component developing agent, a two-component developing agent was produced in the same manner as in Example 1. The evaluation results are shown in Table 12.

TABLE 9

| | TgA | TgB | Tp | TgB − TgA |
|---|---|---|---|---|
| TONER BASE PARTICLES No. | (° C.) | (° C.) | (° C.) | (° C.) |
| TONER BASE PARTICLES 1 | 43 | 52 | 70 | 9 |
| TONER BASE PARTICLES 2 | 44 | 50 | 68 | 6 |
| TONER BASE PARTICLES 3 | 46 | 50 | 68 | 4 |
| TONER BASE PARTICLES 4 | 46 | 51 | 68 | 5 |
| TONER BASE PARTICLES 5 | 50 | 52 | 72 | 2 |
| TONER BASE PARTICLES 6 | 52.5 | 54 | 68 | 1.5 |
| TONER BASE PARTICLES 7 | 51 | 53 | 72 | 2 |

TABLE 10

| | | | | | | TITANIUM OXIDE FINE | | | | | | | |
|---|---|---|---|---|---|---|---|---|---|---|---|---|---|
| | | | SILICA FINE PARTICLES | | | PARTICLES | | FIRST MIXING PROCESS | | | SECOND MIXING PROCESS | | |
| | | TONER | CONCENTRATION OF | PRIMARY | ADDED | PRIMARY | ADDED | PROCESSING | STIRRING | | PROCESSING | STIRRING | |
| | | BASE | HMDS FOR SURFACE | AVERAGE | AMOUNT | AVERAGE | AMOUNT | TEMPERATURE | POWER | MIXING | TEMPERATURE | POWER | |
| | TONER | PARTICLES | TREATMENT | PARTICLE | (part by | PARTICLE | (part by | T1 | W1 | TIME | T2 | W2 | MIXING |
| | No. | No. | (% by mass) | DIAMETER (nm) | mass) | DIAMETER (nm) | mass) | (° C.) | (W/kg) | (min) | (° C.) | (W/kg) | TIME (min) |
| EX. 1 | 1 | 1 | 5 | 130 | 5.0 | 30 | 0.5 | 50 | 140 | 5 | 60 | 10 | 15 |
| EX. 2 | 2 | 2 | 5 | 130 | 5.0 | 30 | 0.5 | 50 | 140 | 5 | 60 | 10 | 15 |
| EX. 3 | 3 | 3 | 5 | 130 | 5.0 | 30 | 0.5 | 50 | 140 | 5 | 60 | 10 | 15 |
| EX. 4 | 4 | 4 | 5 | 130 | 5.0 | 30 | 0.5 | 50 | 140 | 5 | 60 | 10 | 15 |
| EX. 5 | 5 | 5 | 5 | 130 | 5.0 | 30 | 0.5 | 50 | 140 | 5 | 60 | 10 | 15 |
| EX. 6 | 6 | 6 | 5 | 130 | 5.0 | 30 | 0.5 | 53 | 140 | 5 | 60 | 10 | 15 |
| EX. 7 | 7 | 2 | 5 | 130 | 5.0 | 30 | 0.5 | 50 | 30 | 5 | 60 | 10 | 15 |
| EX. 8 | 8 | 2 | 5 | 130 | 5.0 | 30 | 0.5 | 50 | 30 | 5 | 60 | 3 | 15 |
| EX. 9 | 9 | 2 | 5 | 130 | 5.0 | 30 | 0.5 | 50 | 25 | 5 | 60 | 10 | 15 |
| EX. 10 | 10 | 2 | 5 | 130 | 5.0 | 30 | 0.5 | 50 | 140 | 5 | 55 | 10 | 15 |
| EX. 11 | 11 | 2 | 5 | 130 | 5.0 | 30 | 0.5 | 50 | 140 | 5 | 53 | 10 | 15 |
| EX. 12 | 12 | 2 | 5 | 130 | 5.0 | 30 | 0.5 | 50 | 140 | 5 | 60 | 70 | 15 |
| EX. 13 | 13 | 2 | 5 | 130 | 5.0 | 30 | 0.5 | 50 | 30 | 5 | 60 | 15 | 15 |
| EX. 14 | 14 | 2 | 5 | 130 | 5.0 | 30 | 0.5 | 50 | 140 | 5 | 60 | 5 | 15 |
| EX. 15 | 15 | 2 | 5 | 130 | 5.0 | 30 | 0.5 | 50 | 140 | 5 | 60 | 3 | 15 |
| EX. 16 | 16 | 2 | 5 | 130 | 5.0 | 30 | 0.5 | 45 | 140 | 5 | 60 | 10 | 15 |
| EX. 17 | 17 | 2 | 5 | 130 | 5.0 | 30 | 0.5 | 44 | 140 | 5 | 49 | 10 | 15 |
| EX. 18 | 18 | 2 | 5 | 130 | 5.0 | 30 | 0.5 | 45 | 140 | 5 | 67 | 10 | 15 |
| EX. 19 | 19 | 2 | 5 | 130 | 5.0 | 30 | 0.5 | 67 | 140 | 5 | 60 | 10 | 15 |
| EX. 20 | 20 | 2 | 5 | 130 | 5.0 | 30 | 0.5 | 67 | 140 | 5 | 45 | 10 | 15 |
| EX. 21 | 21 | 2 | 5 | 130 | 5.0 | 30 | 0.5 | 50 | 140 | 5 | 44 | 10 | 15 |
| EX. 22 | 22 | 2 | 5 | 130 | 5.0 | 30 | 0.5 | 50 | 140 | 5 | 67 | 10 | 15 |
| EX. 23 | 23 | 2 | 5 | 130 | 5.0 | 30 | 0.5 | 63 | 140 | 5 | 67 | 10 | 15 |
| EX. 24 | 24 | 4 | 5 | 130 | 5.0 | 30 | 0.5 | 50 | 140 | 15 | 60 | 10 | 5 |
| EX. 25 | 25 | 5 | 5 | 130 | 5.0 | 30 | 0.5 | 50 | 140 | 5 | 60 | 10 | 45 |
| EX. 26 | 26 | 4 | 12 | 50 | 5.0 | 30 | 0.5 | 50 | 140 | 5 | 60 | 10 | 15 |
| EX. 27 | 27 | 4 | 7 | 100 | 5.0 | 30 | 0.5 | 50 | 140 | 5 | 60 | 10 | 15 |
| EX. 28 | 28 | 4 | 4 | 180 | 5.0 | 30 | 0.5 | 50 | 140 | 5 | 60 | 10 | 15 |
| EX. 29 | 29 | 4 | 3 | 300 | 5.0 | 30 | 0.5 | 50 | 140 | 5 | 60 | 10 | 15 |
| EX. 30 | 30 | 4 | 2 | 430 | 5.0 | 30 | 0.5 | 50 | 140 | 5 | 60 | 10 | 15 |
| EX. 31 | 31 | 7 | 2 | 130 | 5.0 | 30 | 0.5 | 50 | 140 | 5 | 68 | 10 | 15 |
| COMP. EX. 1 | C1 | 2 | 5 | 130 | 5.0 | 30 | 0.5 | 42 | 140 | 20 | — | — | — |
| COMP. EX. 2 | C2 | 2 | 5 | 130 | 5.0 | 30 | 0.5 | 50 | 140 | 20 | — | — | — |
| COMP. EX. 3 | C3 | 2 | 5 | 130 | 5.0 | 30 | 0.5 | 50 | 140 | 5 | 60 | 2 | 15 |
| COMP. EX. 4 | C4 | 2 | 5 | 130 | 5.0 | 30 | 0.5 | 50 | 18 | 5 | 60 | 10 | 15 |
| COMP. EX. 5 | C5 | 2 | 5 | 130 | 5.0 | 30 | 0.5 | 50 | 140 | 5 | 60 | 75 | 15 |
| COMP. EX. 6 | C6 | 2 | 5 | 130 | 5.0 | 30 | 0.5 | 42 | 140 | 5 | 60 | 10 | 15 |
| COMP. EX. 7 | C7 | 2 | 5 | 130 | 5.0 | 30 | 0.5 | 70 | 140 | 5 | 60 | 10 | 15 |
| COMP. EX. 8 | C8 | 2 | 5 | 130 | 5.0 | 30 | 0.5 | 50 | 140 | 5 | 42 | 10 | 15 |
| COMP. EX. 9 | C9 | 2 | 5 | 130 | 5.0 | 30 | 0.5 | 50 | 140 | 5 | 70 | 10 | 15 |

TABLE 11

| | | WEIGHT | | |
|---|---|---|---|---|
| | | AVERAGE | | |
| | | PARTICLE | | |
| | | DIAMETER | AVERAGE | Tg1st |
| EX. | TONER | D4 (μm) | CIRCULARITY | (° C.) |
| EX. 1 | TONER 1 | 6.6 | 0.952 | 56 |
| EX. 2 | TONER 2 | 6.7 | 0.954 | 55 |
| EX. 3 | TONER 3 | 6.6 | 0.955 | 52 |
| EX. 4 | TONER 4 | 6.8 | 0.950 | 55 |
| EX. 5 | TONER 5 | 6.5 | 0.955 | 54 |
| EX. 6 | TONER 6 | 6.9 | 0.953 | 55 |
| EX. 7 | TONER 7 | 6.7 | 0.954 | 55 |
| EX. 8 | TONER 8 | 6.7 | 0.954 | 51 |
| EX. 9 | TONER 9 | 6.7 | 0.954 | 55 |
| EX. 10 | TONER 10 | 6.7 | 0.954 | 53 |
| EX. 11 | TONER 11 | 6.8 | 0.954 | 51 |
| EX. 12 | TONER 12 | 6.7 | 0.954 | 55 |
| EX. 13 | TONER 13 | 6.7 | 0.954 | 55 |
| EX. 14 | TONER 14 | 6.7 | 0.954 | 53 |
| EX. 15 | TONER 15 | 6.8 | 0.954 | 51 |
| EX. 16 | TONER 16 | 6.8 | 0.954 | 55 |
| EX. 17 | TONER 17 | 6.8 | 0.952 | 53 |
| EX. 18 | TONER 18 | 6.9 | 0.956 | 55 |
| EX. 19 | TONER 19 | 6.8 | 0.955 | 53 |
| EX. 20 | TONER 20 | 6.9 | 0.955 | 53 |
| EX. 21 | TONER 21 | 6.8 | 0.952 | 52 |
| EX. 22 | TONER 22 | 7.0 | 0.956 | 56 |
| EX. 23 | TONER 23 | 7.0 | 0.950 | 57 |
| EX. 24 | TONER 24 | 6.8 | 0.955 | 54 |
| EX. 25 | TONER 25 | 6.5 | 0.950 | 54 |
| EX. 26 | TONER 26 | 6.8 | 0.950 | 55 |
| EX. 27 | TONER 27 | 6.8 | 0.950 | 55 |
| EX. 28 | TONER 28 | 6.8 | 0.950 | 55 |
| EX. 29 | TONER 29 | 6.8 | 0.950 | 56 |
| EX. 30 | TONER 30 | 6.8 | 0.950 | 57 |
| EX. 31 | TONER 31 | 6.8 | 0.952 | 54 |
| COMP. EX. 1 | TONER C1 | 6.7 | 0.950 | 46 |
| COMP. EX. 2 | TONER C2 | 6.9 | 0.952 | 52 |
| COMP. EX. 3 | TONER C3 | 6.8 | 0.954 | 49 |
| COMP. EX. 4 | TONER C4 | 6.7 | 0.954 | 55 |
| COMP. EX. 5 | TONER C5 | 6.8 | 0.954 | 55 |
| COMP. EX. 6 | TONER C6 | 6.7 | 0.953 | 55 |
| COMP. EX. 7 | TONER C7 | CANNOT OBTAIN TONER | | |
| | | DUE TO AGGLOMERATION | | |
| COMP. EX. 8 | TONER C8 | 7.1 | 0.952 | 49 |

| | | |
|---|---|---|
| COMP. EX. 9 | TONER C9 | CANNOT OBTAIN TONER |
| | | DUE TO AGGLOMERATION |

TABLE 12

| | | | | EVALUATION3 | EVALUATION4 | | EVALUATION5 |
|---|---|---|---|---|---|---|---|
| | | | EVALUATION2 | LOW | TRANSFER- | TRANSFERABILITY | MEMBER |
| | | EVALUATION1 | STORAGE | TEMPERATURE | ABILITY | (AFTER | CONTAM- |
| | TONER | COHESIVENESS | STABILITY | FIXABILITY | (EARLY STAGE) | DURABILITY) | INATION |
| EX. 1 | TONER 1 | A | A | A (500) | A (0.02) | A (0.03) | A (0.04) |
| EX. 2 | TONER 2 | A | A | B (480) | A (0.02) | A (0.04) | A (0.05) |
| EX. 3 | TONER 3 | B | C | B (420) | B (0.06) | B (0.09) | A (0.07) |
| EX. 4 | TONER 4 | A | A | B (400) | A (0.04) | B (0.07) | A (0.06) |
| EX. 5 | TONER 5 | B | B | C (340) | B (0.08) | C (0.12) | B (0.12) |
| EX. 6 | TONER 6 | A | A | C (300) | C (0.11) | C (0.16) | B (0.11) |
| EX. 7 | TONER 7 | A | A | B (480) | B (0.08) | B (0.08) | A (0.05) |
| EX. 8 | TONER 8 | A | C | B (480) | B (0.06) | B (0.08) | A (0.06) |
| EX. 9 | TONER 9 | A | A | B (480) | C (0.10) | C (0.14) | B (0.12) |
| EX. 10 | TONER 10 | A | B | B (480) | A (0.02) | A (0.04) | A (0.05) |
| EX. 11 | TONER 11 | B | C | B (480) | A (0.02) | B (0.06) | A (0.06) |
| EX. 12 | TONER 12 | A | B | B (480) | B (0.06) | B (0.09) | A (0.07) |
| EX. 13 | TONER 13 | A | B | B (480) | C (0.10) | C (0.17) | B (0.11) |
| EX. 14 | TONER 14 | A | B | B (480) | A (0.03) | A (0.04) | A (0.07) |
| EX. 15 | TONER 15 | B | C | B (480) | A (0.03) | A (0.04) | A (0.07) |
| EX. 16 | TONER 16 | A | A | B (480) | B (0.07) | B (0.09) | B (0.15) |
| EX. 17 | TONER 17 | A | B | B (480) | C (0.10) | C (0.15) | C (0.24) |
| EX. 18 | TONER 18 | C | A | B (480) | B (0.06) | B (0.08) | C (0.21) |
| EX. 19 | TONER 19 | B | B | B (480) | B (0.06) | B (0.08) | A (0.05) |
| EX. 20 | TONER 20 | C | B | B (480) | B (0.06) | C (0.11) | A (0.05) |
| EX. 21 | TONER 21 | B | C | B (480) | A (0.04) | B (0.07) | A (0.05) |
| EX. 22 | TONER 22 | C | A | B (480) | B (0.06) | B (0.09) | A (0.05) |
| EX. 23 | TONER 23 | C | A | B (480) | C (0.12) | C (0.17) | A (0.05) |
| EX. 24 | TONER 24 | A | C | B (400) | B (0.08) | C (0.15) | B (0.10) |
| EX. 25 | TONER 25 | B | B | C (340) | B (0.08) | C (0.13) | B (0.13) |
| EX. 26 | TONER 26 | A | A | B (400) | A (0.04) | C (0.12) | A (0.03) |
| EX. 27 | TONER 27 | A | A | B (400) | A (0.04) | B (0.08) | A (0.05) |
| EX. 28 | TONER 28 | A | A | B (400) | A (0.04) | B (0.06) | A (0.09) |
| EX. 29 | TONER 29 | A | A | B (400) | A (0.03) | B (0.05) | B (0.16) |
| EX. 30 | TONER 30 | A | A | B (400) | A (0.02) | B (0.05) | C (0.25) |
| EX. 31 | TONER 31 | B | B | C (340) | B (0.09) | C (0.17) | B (0.16) |
| COMP. EX. 1 | TONER Cl | A | D | B (480) | D (0.25) | E (0.33) | D (0.13) |
| COMP. EX. 2 | TONER C2 | B | B | B (480) | C (0.12) | D (0.22) | A (0.06) |
| COMP. EX. 3 | TONER C3 | B | D | B (480) | B (0.06) | B (0.09) | A (0.06) |
| COMP. EX. 4 | TONER C4 | A | B | B (480) | D (0.21) | D (0.26) | C (0.22) |
| COMP. EX. 5 | TONER C5 | B | B | B (480) | C (0.15) | D (0.23) | A (0.07) |
| COMP. EX. 6 | TONER C6 | A | A | B (480) | D (0.20) | D (0.25) | D (0.37) |
| COMP. EX. 7 | TONER C7 | D | — | — | — | — | — |
| COMP. EX. 8 | TONER C8 | B | D | B (480) | B (0.08) | D (0.21) | C (0.25) |
| COMP. EX. 9 | TONER C9 | D | — | — | — | — | — |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-264229, filed Dec. 20, 2013, which is hereby incorporated by reference herein in its entirety.

What is claimed is:

1. A toner manufacturing method, comprising:
a first mixing step of mixing toner base particles,
each of which contains a colorant, a crystalline resin, an amorphous resin, and wax with inorganic fine particles to obtain a mixture; and
a second mixing step of further mixing the mixture,
wherein the first mixing step and the second mixing step are steps for performing the mixing using a mixing device having a stirring unit for imparting mechanical impact force in a container, and
when a processing temperature in the first mixing step is indicated as T₁ (° C.), a stirring power of the mixing device imparted to a unit mass of a coated material in the first mixing step is indicated as W₁ (W/kg), a processing temperature in the second mixing step is indicated as T₂ (° C.), and a stirring power of the mixing device imparted to the unit mass of a coated material in the second mixing step is indicated as W₂ (W/kg), the following expressions (1), (2), (3), and (4) are satisfied,
TgA≦T₁≦Tp (1),
TgA≦T₂≦Tp (2),
3≦W₂ (3)
W₂≦½W₁ (4)
wherein, in the expressions, Tp (° C.) shows an onset temperature of a maximum endothermic peak derived from the crystalline resin measured when the temperature is raised from 20° C. to 180° C. at a temperature rise rate of 10° C./min in differential scanning calorimeter (DSC) measurement in which the toner base particles are measurement specimens, and
TgA (° C.) shows a glass transition temperature in a second temperature rise measured when the temperature is raised from 20° C. to 180° C. at a temperature rise rate of 10° C./min, the temperature is reduced to 20° C. at a temperature decrease rate of 50° C./min, and immediately after the cooling, the temperature is raised from 20° C. to 180° C. at a temperature rise rate of 10° C./min in the DSC measurement in which the toner base particles are measurement specimens.

2. The toner manufacturing method according to claim 1, wherein T₁ (° C.) and T₂ (° C.) satisfy the following expression (5),
T₁+5<T₂ (5).

3. The toner manufacturing method according to claim 1, wherein W₁ (W/kg) satisfies following expression (6),
30≦W₁ (6).

4. The toner manufacturing method according to claim 1, wherein the toner satisfies the following expression (7),
TgB−TgA≧5 (7),
wherein TgB (° C.) shows a glass transition temperature in a second temperature rise measured when the temperature is raised from 20° C. to 180° C. at a temperature rise rate of 10° C./min, the temperature is reduced to 50° C. at a temperature decrease rate of 50° C./min, the temperature is held at 50° C. for 20 minutes, the temperature is reduced to 20° C. at a temperature decrease rate of 50° C./min, the temperature is held at 20° C. for 10 minutes, and then the temperature is raised from 20° C. to 180° C. at a temperature rise rate of 10° C./min in the DSC measurement in which the toner base particles are measurement specimens.
